(19) United States
(12) Patent Application Publication
(10) Pub. No.: US 2014/0217788 A1
(43) Pub. Date: Aug. 7, 2014

(54) VEHICLE SEAT APPARATUS FOR COLLISION INJURY PREVENTION

(71) Applicants: Michael Norwood, Sedona, AZ (US); Viktor Kapiliovich, Holland, PA (US)

(72) Inventors: Michael Norwood, Sedona, AZ (US); Viktor Kapiliovich, Holland, PA (US)

(21) Appl. No.: 14/173,810

(22) Filed: Feb. 5, 2014

Related U.S. Application Data
(60) Provisional application No. 61/760,805, filed on Feb. 5, 2013.

(51) Int. Cl. B60N 2/427

(52) U.S. Cl. CPC B60N 2/427
USPC 297/216.12

(57) ABSTRACT

A vehicle safety device for decreasing injury to occupants resulting from a collision, comprising enhanced impact absorbing apparatuses: (1) headrests and seatbacks with conical or cylindrical holes and layers of material to absorb impact forces; (2) 4 embodiments of apparatuses attaching the headrests to the seatback comprising shock absorption means to reduce whiplash injuries; (3) spring loaded means of attaching the seat bottom to the vehicle floor to provide the seats recoil mechanisms for collisions from all directions; (4) seatbelts with all points of contact to the seat to provide the seatbelts recoil mechanisms, and comprising gel and/or foam layers and a flexible weave design; (5) seat tilt mechanisms that enable the seat to recoil during a collision; and (6) airbags with multiple layers of material of increasing impact absorption from the occupants to the dashboard and steering wheel.

### FIELD OF THE DISCLOSURE

The present invention relates to seats within vehicles comprising a headrest, apparatus attaching headrest to seatback, seatbelt, seat bottom attachment, seatback, and airbag design that are engineered to prevent injuries to occupants as a result of a collision.

### BACKGROUND OF THE DISCLOSURE

The National Highway Traffic Safety Administration reports there were 5,338,000 vehicular crashes in 2011¹. Of these crashes, 29,757 were fatal² and 2,091,062³ caused injury. The most common type of vehicular injury is called acceleration/deceleration injury, or, more commonly whiplash. Approximately 80% of these injuries are caused by rear or front end collisions, which are the prime injuries this disclosure aids in lessening and preventing. ¹Source: General Estimate System²Source: Fatal Analysis Reporting System (FARS)³Source: Fatal Analysis Reporting System (FARS)

The mechanism of injury in rear-end collisions is typically the violent whipping backward of the head, which rebounds off of the headrest, then the violent whipping forward of the head, which then rebounds off of the airbag, and then the violent whipping back of the head into the headrest again. In front-end collisions—commonly occurring in the form of a driver running into the back of another vehicle or some type of object—the mechanism is similar, but in reverse: the violent whipping forward of the head into the airbag, then the high-speed propulsion backward of the head into the headrest, then the violent whipping forward of the head again.

Whether the collision is front or rear-end, the result is a tearing, shearing and inflammation of soft tissue fibers found in the supporting structures of the spine. These include ligaments, tendons, muscles and the annular fiber of spinal discs encasing the central disc nucleus. If the tearing and inflammation of the annular fibers of the disc is great enough, disc nuclear protrusion will result and possible disc herniation. Either can result in nerve root damage and subsequent radicular neuropathy—mainly pain or numbness along the entire nerve tract extending into the arm, hands and fingers.

In the most severe of such acceleration/deceleration injuries, paralysis can result, and sometimes death. This can be caused by either fracture of some component of the cranium or vertebral structure which thus causes severance of delicate nerve, spinal cord and/or brain stem and other brain tissues.

In addition to the nerve, spinal cord and soft tissue damage which can be caused by even relatively low impact rear-end or front-end collisions of as little as a few mph, brain damage can result as well. The brain floats inside the hard walls of the cranium in a bed of protective meningeal fluid. This fluid prevents the delicate brain from touching the hard bone structure of the cranium. However, in any acceleration/deceleration injury, the brain is propelled forward and backward into the hard bone causing swelling and potential damage to brain tissue. This front-back-front or back-front-back collision of the brain into the cranium is called “contre-coup”—literally “opposing hits”.

Age, size and relative tensile strength of the supporting soft tissue structures play a major role in the degree of injury experienced in each individual, though with enough impact, anyone can experience some type of contre-coup brain injury and whiplash spinal injury even in seemingly low-impact 1 to 10 mile per hour collisions.

The contribution of seatbelts and airbags in the prevention of death or severe injury in vehicular collisions have been great. Both prevent the occupants' face and cranium from contacting the hard surfaces of the steering wheel, window, dashboard or even the occupant's own knees. However, neither prevent the “whiplash” and “contre-coup” type of damage caused by the violent front-back-front or back-front-back acceleration/deceleration of head and neck movement.

Prior art disclosures attempting to address the mechanics of whiplash have been, in general, much higher in cost and complex in construction than the various embodiments of the present disclosure. Many of the prior art systems teach the use of sensors and airbags located inside the seat and headrest (see U.S. Pat. Nos. 5,580,124; 5,694,320; 6,088,640; 7,588,115; 7,604,080; 5,833,312; 7,431,331; 3,893,703; and, 7,523,957).

For example, U.S. Pat. No. 7,926,871 teaches the use of two different foam densities in the headrest to “guide the head” and “reduce torque”. However, U.S. Pat. No. 7,926,871's two-density foam layers have a fraction of the impact absorption capability needed to protect an occupant's head upon impact with the headrest.

U.S. Pat. No. 7,410,218 teaches using separate portions of the headrest structure for the cranium versus the cervical spine to better support the cervical spine upon impact. The disadvantage of this design (as well as U.S. Pat. No. 5,5581,204) is that the headrest would have to be exactly positioned to the occupant's cervical spine and to be a close size match to the occupant to operate effectively, whereas the present disclosure's exemplifications have much greater leeway regarding position and size of the occupant.

Also, the rotational shock damping mechanism in U.S. Pat. No. 7,410,218—designed primarily to brace the cervical spinal curve's posterior convexity from distorting—would though provide minimal impact damping of the overall cranium and cervical spine motion as a unit. Thus U.S. Pat. No. 7,410,218 has a much higher potential for rebound than the separate or combined posterior and rotational damping embodiments of the present disclosure.

U.S. Pat. No. 6,135,561 teaches a pivot mechanism inside the seatback rather than at the headrest seatback joint. This design could not be used on any seatback other than one designed to support the present disclosure, whereas most of the present disclosure's exemplifications of headrest designs could be adopted for almost any seatback.

U.S. Pat. No. 4,929,027 contemplates a belt that also has shock damping features. However, its features expand the seatbelt's width to spread the force of impact over a larger portion of the occupant's shoulder and chest, thereby reducing injury. The present disclosure's embodiments are distinct from this, primarily functioning to expand the length of the seatbelt and provide better shock damping of the seatbelt material in its contact to the occupant's chest and shoulder. The present disclosure can be designed separately or potentially in conjunction with U.S. Pat. No. 4,929,027.

U.S. Pat. No. 6,988,743 discloses a methodology for the front portion of an airbag to be inflated before the back portion. It is assumed the primary purpose of this earlier disclosure is to provide protection by the airbag to the occupant while the occupant is a further distance from impacting the steering wheel or dashboard. The present disclosure can utilize this innovation of front-first versus rear-first air-pressurization and filling. However, the advantage of the present disclosure is its configuration allows for a higher volume of air to be retained in the back compartment(s) of the air bag nearest to the steering wheel or dashboard compared to the front compartments nearest to the occupant after impact from the occupant's head and body into the airbag. This progressive-volume cushioning and progressive release of air from the front compartments to the back compartments after impact of the occupant into the airbag reduces rebound of the occupant's body back toward the seat thereby reducing subsequent rebound/whiplash injury that is more likely to occur with U.S. Pat. No. 6,988,743 and other prior art air bags compared to the design taught in the present disclosure.

While these disclosures indeed appear highly capable of ameliorating injury, these more complicated designs and apparatuses come with a much higher potential for electronic and parts failure compared to simpler innovations that accomplish the same purpose equally, if not more effectively. The fact that the automobile industry has not had a widespread adoption (if any at all) of these prior art systems, may be telling of the cost and construction issues they entail. The present disclosure teaches a series of innovations that are in general much simpler, more cost effective and containing fewer moving parts while at the same time providing considerable protection against whiplash and other types of impact injuries.

### SUMMARY OF THE DISCLOSURE

The present invention is designed to help prevent injury primarily in front and rear-end vehicle (e.g. automobile, airplane seat, amusement ride, etc.) collisions. The bottom seat portion of this invention also helps prevent injury in side-impact collisions. The disclosure teaches simple innovations that allow for small areas of “play” in multiple joints and points of contact between the occupant and the car which normally have little or no play built into them. It is noted that one or more of the seat components of the present invention (e.g. the headrest, connection to seatback, seatbelt, seatback, attachment of seat to floor, and airbag), and any combination thereof, may be interchanged with seat components on any moving vehicle that may be involved in a collision with another vehicle or object or living entity (e.g. deer).

Via a number of simple innovations in the headrest, headrest attachment to the seatback, seatbelt, seat bottom attachment to the floor, seatback, and airbag design—all largely overlooked areas of whiplash prevention—this invention aids in absorbing the acceleration/deceleration motion caused by front or rear vehicular impact collisions. The purpose of this headrest, seat and seatbelt re-design is to significantly slow or stop the acceleration/deceleration and contre-coup forces causing so much potential shoulder, neck, back and head injury.

Headrest: The headrest of the present invention primarily possesses four impact-absorbing features, comprising: 1) use of memory foam, gel packs or other more impact-absorbing materials compared to the use of standard single-density foam; 2) use of various densities in different areas of the headrest via holes or different density foams or configuration of gel, air or other types of spaced packets; 3) use of a semi-collapsible headrest structure; and, 4) use of absorptive shock absorber-like mechanisms in the apparatuses connecting the head rest to the seatback.

Apparatus to connect headrest to seatback: The present invention further comprises four different embodiments for the apparatus connecting the headrest to the top of the seatback. Each embodiment provides additional impact absorbing properties as compared to standard apparatuses used in vehicles today, which normal comprises ridge materials such as vertical rods. The four embodiments are as follows. 1) A “C-bar” shaped design with a helical compression spring attached to a “C” shaped bar (e.g. two approximately 90 degree angles) that extends into the backseat compartment and is aligned in the direction of the force of impact to impede backward snapping of the occupant's head, and to assist in preventing rebounding of the occupant's head off of the headrest. 2) A Horizontal Headrest/Seatback Shock Absorber comprising a cylinder and spring loaded means housed directly between the headrest and seatback (versus behind as in the C-Shaped design supra), that acts to recoil the headrest on impact. 3) A Torus Headrest/Seatback Shock Absorber comprising the headrests attached directly to a lever possessing an internal torus with a spring and an external torus inside the spring which is attached to the back of the seat so as to absorb impact on both the horizontal and vertical planes. 4) And, a Vertical Headrest/Seatback Shock Absorber Apparatus comprising vertically oriented spring loaded means in the top surface of the seatback and slots permitting movement of the headrest backward to allow the headrest to recoil upon sufficient impact of the occupant's head against the headrest.

Seat: In addition, several impact-absorbing mechanisms are used in the seat as well, comprising: 1) use of memory foam, gel packs or some absorptive substance instead of standard foam; 2) use of various densities in different areas of the seat via holes or different density foams or configuration of gel, air or other types of spaced packets; 3) a variable retraction/extension seat tilt back mechanism that allows for a tiny bit more play than the standard angling mechanism used to angle seats; and, 4) use of absorptive shock absorber-like mechanisms in the attachment of the seat to the floor.

Per (3) supra: An flexible locking apparatus of a vehicular seat, comprising a mechanism able to increase a seatback's backward motion during a front or rear impact collision,

the mechanism comprising: a) a tilt adjustment knob residing on a seat bottom side and configured to manually move a seat back from a position perpendicular to and backward from a seat bottom; b) a cam embedded vertically in a seatback bottom surface and connected on a bottom end to a top surface of a seat bottom; c) a cylinder member residing vertically within the cam; and, d) a shock absorption means residing below the cylinder configured to slow the downward movement of the cylinder and cam and thus the backward then forward movement of the seatback upon impact. The shock absorption means comprises a compression spring, air, oil, or any combination thereof.

Per (4) supra, the various embodiments comprise a vehicular seat fixation apparatus configured to allow absorption of impact when a vehicle is impacted from any direction, comprising: a) a female member embedded in the bottom surface of a seat bottom and comprising holes evenly distributed around the periphery of the female member; b) a male member affixed to a top surface of a floor attachment member and comprising shock absorption means evenly distributed around and extending perpendicular to the periphery of the male member; c) wherein the shock absorption members fit into the holes of the female member when the male member is inserted into the female member; and, d) wherein the bottom surface of the floor attachment member is affixed to the top surface of the floor of a vehicle. The male and female members may be octagonal shaped and the shock absorption means comprises torsional springs.

Seatbelt: In addition, several impact-absorbing mechanisms are used in the seatbelt as well, comprising the following. 1) A gel, foam or some absorptive substance affixed to the seat belt in three different embodiments: a) on one side facing the occupant, b) encased between two outer layers of the seat belt material, such as weave material; and c) completely encasing seat belt material, such as weave material. 2) A slightly flexible fiber weave is used in lieu of or in addition to standard non-stretchable seat belt material, such as in the central portion of the two outer layers (embodiment 1b), similar to the manner in which climbing rope is weaved to allow for “bounce” when a climber falls. Upon a climber falling, this flexible weave prevents the jarring high impact and higher potential for injury that would be caused with a non-flexible rope. A similar attenuation of high impact forces occurs in embodiments of the invention's seatbelt design. 3) A variable retraction/extension mechanism that allows for a tiny bit more play than the standard seatbelt. In concept, this would work similar to the variable tension mechanism used in fishing reels. Regarding fishing reels, without this variable tension mechanism that allows a larger fish to pull slightly backwards against the line, the line would often break. Similarly, by creating a variable tension mechanism in a seat belt, a lot of soft tissue injury can be prevented without losing the seatbelt's life-saving retention capacities that prevent the body from propelling forward. 4) And, a use of a seatbelt design attached to the seat at all points of contact to allow the body to move with the flexible mechanisms of embodiments of the disclosures' multiple joints rather than being attached to the fixed structure of the car body.

Airbag: In addition, an impact-absorbing mechanism is used in the airbag as well to increase the ability of the airbags to shield the front seat occupant and driver from injury due to whiplash as compared to prior art air bags. The airbag device affixed to the vehicle dashboard and steering wheel comprises multiple layers of material of increasing density, resiliency, and impact absorption in the orientation of the occupants to the dashboard and steering wheel. In one embodiment, the multiple layers are inflated with increasing amounts of pressure from the occupants to the dashboard and steering wheel. In another embodiment, the multiple layers comprise conical shaped holes where the widest diameter is near the occupant and the tip of the cone is near the dashboard and steering wheel. And in yet another embodiment, the multiple layers comprise air packets with the packets near the occupant having the lowest density and the packets near the dashboard and steering wheel having the highest density.

### BRIEF DESCRIPTION OF THE DRAWINGS

The above and other features, aspects, and advantages of the present invention will become better understood with regard to the following description, appended claims, and accompanying drawings where:

FIGS. 1-5 illustrate one embodiment of the headrest with holes of decreasing diameter (from center to outside periphery on the front surface); and aligned from the front to the back of the headrest along a single axis, thus creating a conical channel.

FIGS. 6-10 illustrate a second embodiment of the headrest with the holes of uniform diameter and evenly aligned on the front surface of the headrest; and aligned at an angle from the front to the back of the headrest to form a conical or cylindrical channel.

FIGS. 11-18 provide a series of front, lateral and diagonal side-by-side views to illustrate pre and post-impact views of the head position in relationship to the headrest invention's capacity of absorbing the impact and slowing the rebounding of the head forward.

FIGS. 19 and 20 illustrate one embodiment of the inside structure of the headrest comprising rectangular shaped layers within layers of variable density impact absorbing materials. FIG. 19 is a front overhead perspective view; and FIG. 20 is an expanded view of FIG. 19 showing a breakout view of each layer of material.

FIGS. 21 and 22 illustrate a second embodiment of the inside structure of the headrest comprising oval or “onion-shaped” layers within layers of impact absorbing materials. FIG. 21 is a front overhead perspective view; and FIG. 22 is an expanded view of FIG. 21 showing a breakout view of each layer of variable-density material.

FIGS. 23-27, 28A and 28B illustrate the first embodiment of an attachment apparatus joining the headrest to the top of the seatback, and comprising a curved “C” bar with a cover housing a helical spring aligned with the direction of impact forces.

FIGS. 29-31 and 32A-32D illustrate the second embodiment of an attachment apparatus joining the headrest to the seatback comprising a Horizontal Headrest/Seatback Shock Absorber.

FIGS. 33-35, 36A, 36B, 37-38 illustrate the third embodiment of the headrest/seatback attachment apparatus comprising the Torus Headrest/Seatback Shock Absorber.

FIGS. 39-42, and 43A-43D illustrate the fourth embodiment of the headrest/seatback shock absorber comprising the Vertical Headrest/Seatback Shock Absorber Apparatus.

FIGS. 44-46 illustrate an embodiment of conical shaped channels extending through the seatback's structure for an increase in impact absorption.

FIGS. 47A, 47B, 48A, 48B, 49A, 49B, 50A, 50B and 51A-51D depict embodiments of the disclosure's flexible locking (e.g. seat backward/forward tilt) mechanism.

FIGS. 52-56 an embodiment of the disclosure's impact-absorbing mechanism's attachment of the seat to the floor.

FIGS. 57-59 depict various combinations of conical-shaped hole design comprising one or more foam and/or gel layers within the seatbelt straps.

FIG. 60 illustrates the impact-resistant material made as a moveable sleeve surrounding the belt. Points of attachment for the belt are omitted to illustrate this sleeve can be used in standard seatbelt to car body design or embodiments of the disclosure's seatbelt to seat design.

FIGS. 61-63 illustrate the seatbelt attached to the seat versus the floor of the vehicle.

FIGS. 64 and 65 illustrate a slightly flexible weave used in an embodiment of the invention's seatbelt fully or with sections of the belt containing weave material.

FIGS. 66 and 67 illustrate a multi-density multi-bagged airbag device.

### DETAILED DESCRIPTION

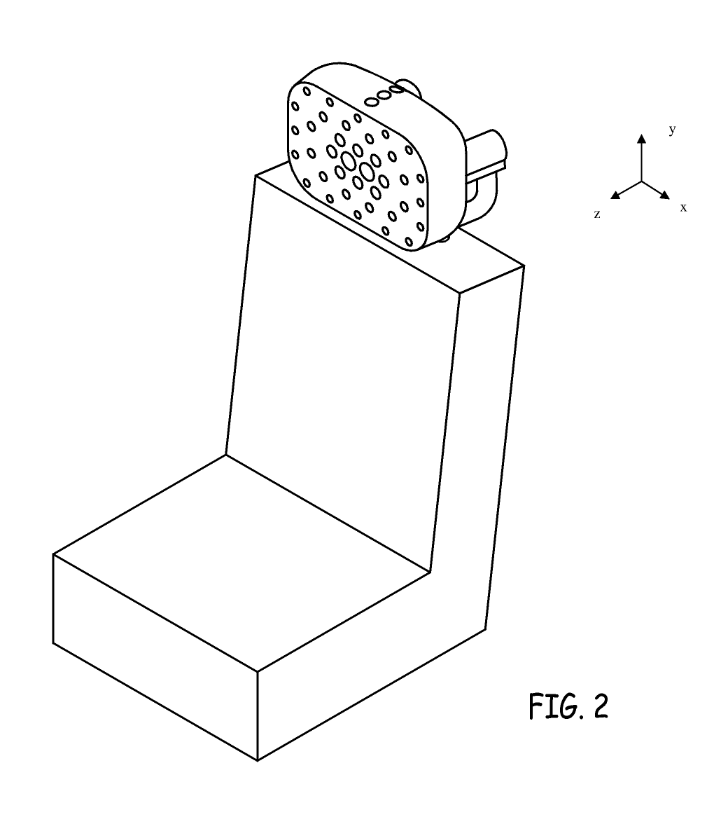

As used herein, the “Z-Axis” refers to forward and backward movement within the cab of a vehicle, the “X-Axis” refers to side-to-side movement, and the “Y-Axis” refers to up and down movement (see FIG. 2, diagram for axes' orientation).

As used herein, “Shock Absorbing Means” refers to any apparatus widely known in the mechanical engineering art to absorb impact forces, such as compression and torsional springs.

Headrest with Straight and Angled Holes

The headrest in some embodiments as depicted in the illustrations will be larger than the normal headrest, and in other embodiments, it may be the smaller standard size. Additionally, the standard vinyl or suede covering a headrest is removed in all these figures to reveal the embodiments of the disclosure's headrest design.

### Straight Holes of Variable Sizes

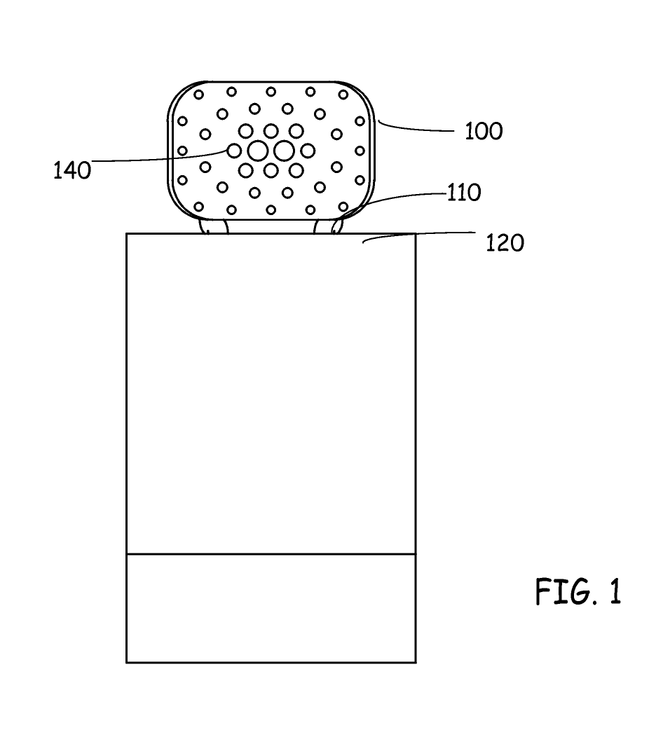

As illustrated in FIGS. 1-5, holes are drilled or other wise formed into the foam of the headrest. The holes are larger and/or greater in number in the center and successively smaller and/or lesser in number as they spread toward the periphery. The purpose of these varying sized and/or spaced holes is to provide increased absorption in the center of the headrest where the back of the skull first impacts the foam. With a larger horizontal width design, the greater density toward the lateral periphery of the headrest actually slightly “grips” the head to slow the heads forward motion after backward impact into the headrest. An embodiment of the disclosure's design also has a series of holes in the center vertical plane of the headrest to allow the headrest to slightly “flex” around that central vertical plane axis allowing a further “gripping” effect of the head.

In addition, memory foam, gel or other impact-optimized material can be used in embodiments of the disclosure to prevent an immediate rebounding compared to the standard single-density foam design. This delay in rebounding of the foam causes additional absorption of the impact without being another factor in propelling the head forward.

### Conical Holes

The holes in some embodiments may be conical in shape with the larger sized portion of the holes' cone located on the front surface of the foam/headrest and the smaller closed portion of the hole's cone toward the back of the foam/headrest. In different embodiments, the holes may actually extend totally through the foam and in others they may not extend totally through. The purpose of the conical hole structure in the sample embodiment would be to provide lesser density toward the front of the headrest for greater absorptive effect, and higher density toward the back of the headrest to provide more stability for the headrest structure.

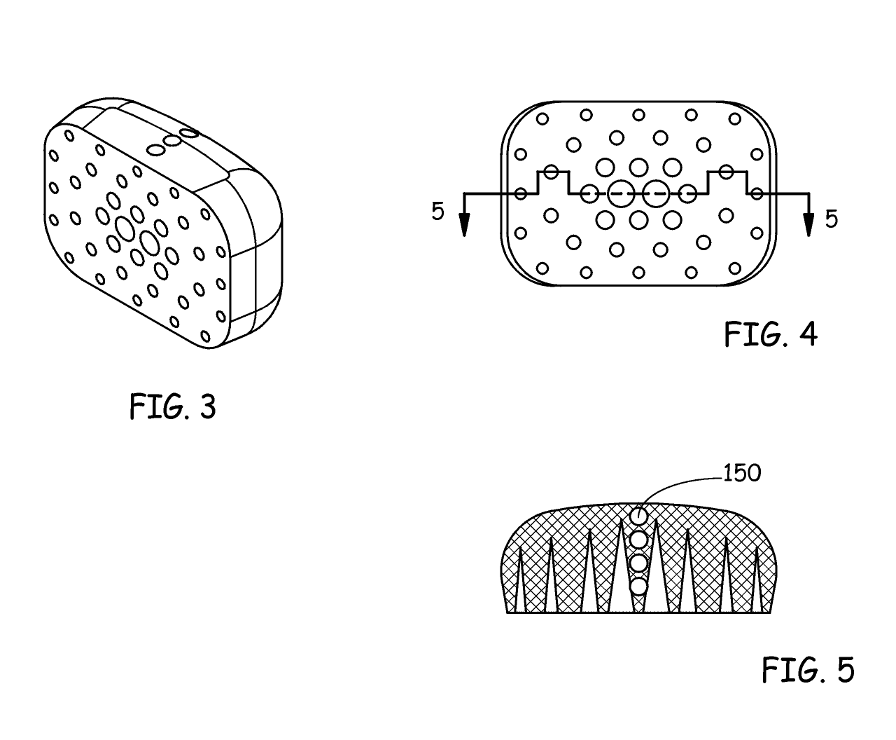

FIGS. 1-5 illustrate one embodiment of the headrest with holes of decreasing diameter (from center to outside periphery on the front surface, and from front to back so as to create a conical hole). In this embodiment, the holes are aligned straight from the front to the back of the headrest along a single axis, thus creating multiple conical channels (see FIG. 5) that may pass almost or completely through the thickness of the headrest. FIG. 1 is a front perspective view (and FIG. 2 is an overhead front perspective view), of the headrest 100 and the apparatus 110 joining headrest to the top of the seatback 120, and with holes 140 configured along outward radiating lines. FIG. 3 is an overhead front perspective view of the headrest alone, and FIG. 4 is a front view of the headrest with a line “5” indicating the view of FIG. 5, which is an overhead cross-sectional view of the headrest. In addition to the conical holes aligned from the front to back of the headrest, FIG. 5 illustrates that there are vertical channels 150 running through the center of the headrest to maximize the amount of impact absorption of the headrest at its center where the occupant's head would directly collide during a front or rear end collision (e.g. primarily in the “−z axis direction”, but also within the plane created by the “x, z axis”).

### Angled Holes

The holes in other embodiments can be drilled at angles to the center. The longer length holes would create lower density and provide more impact-absorptive capacity and would be located toward the center of the headrest, and the gradually shortened length of the holes would provide higher density yet lesser impact-absorptive capacity toward the periphery.

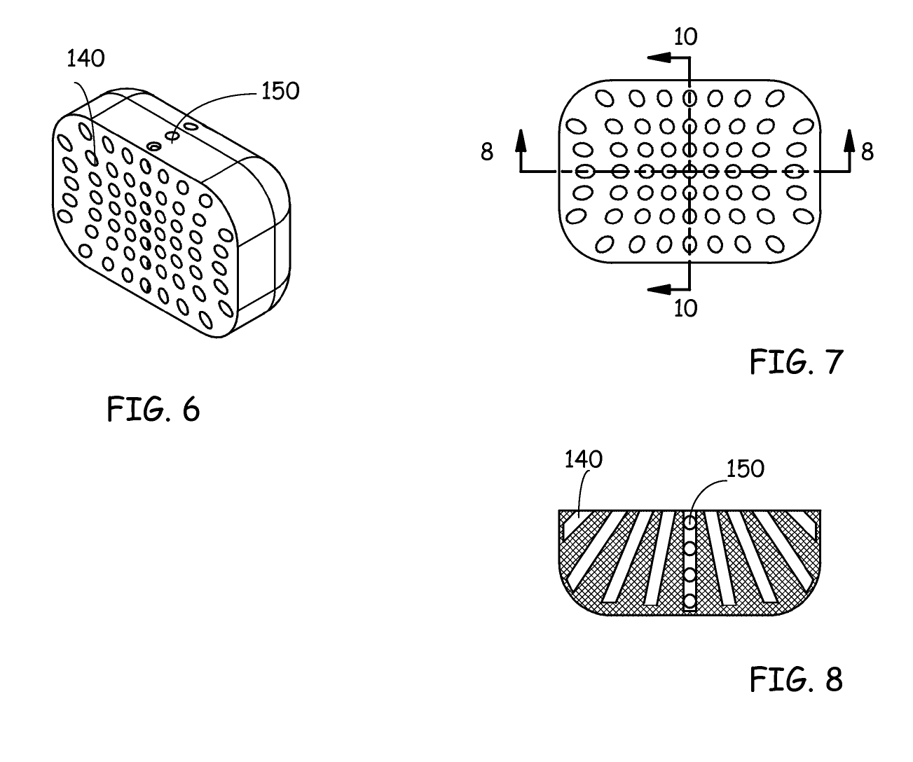

FIGS. 6-10 illustrate a second embodiment of the headrest comprising a pattern of holes of uniform diameter and density from the center to the outer periphery on the front surface of the headrest. The holes may further extend through the thickness of the headrest from the front surface to the back surface, and the channels created by the holes may be of uniform diameter to create cylindrical channels, or they can be of decreasing diameter through the headrest to create conical channels that radiate outward from the center of the headrest. As in the previous embodiment, the channels may go entirely through the headrest or almost through.

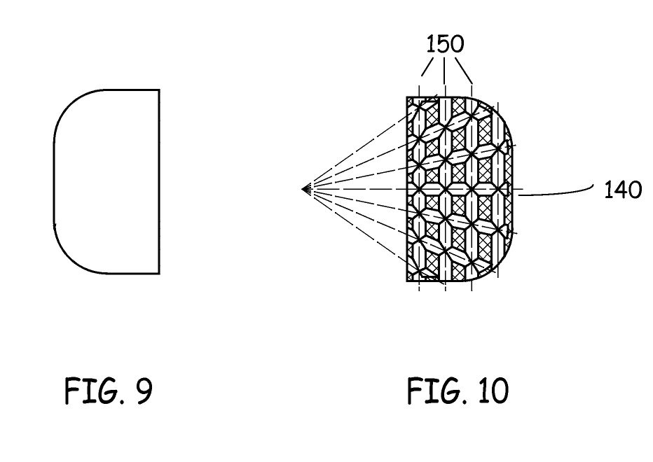

FIG. 6 is an overhead front perspective view of the headrest with the holes 140 of uniform diameter along the face of the headrest, and multiple rows of vertical channels 150 along the center of the headrest. FIG. 7 is a front view of the same headrest with a line “8” on the x-axis to represent the overhead cross-sectional view as shown in FIG. 8, and a line “10” on the y-axis to represent a cross-sectional side view as shown in FIG. 10, with the vertical channels 150 and the conical or cylindrical channels 140 radiating out from the front to the back of the headrest. And FIG. 9 is a left side view of the headrest.

### Pre & Post Impact Views

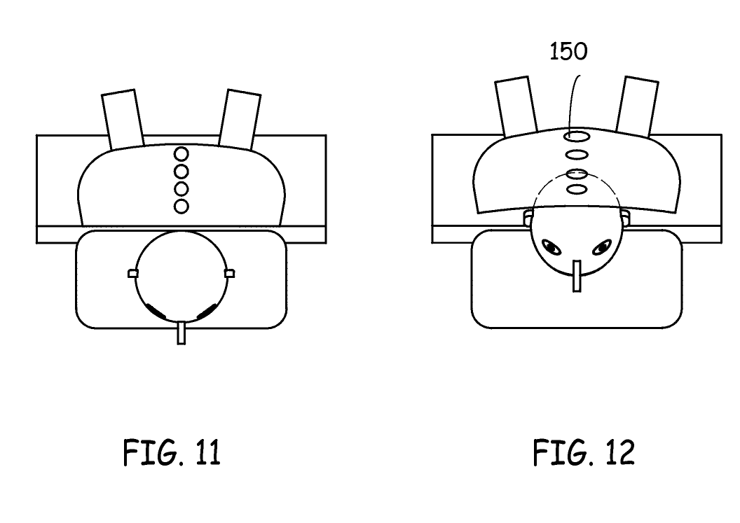

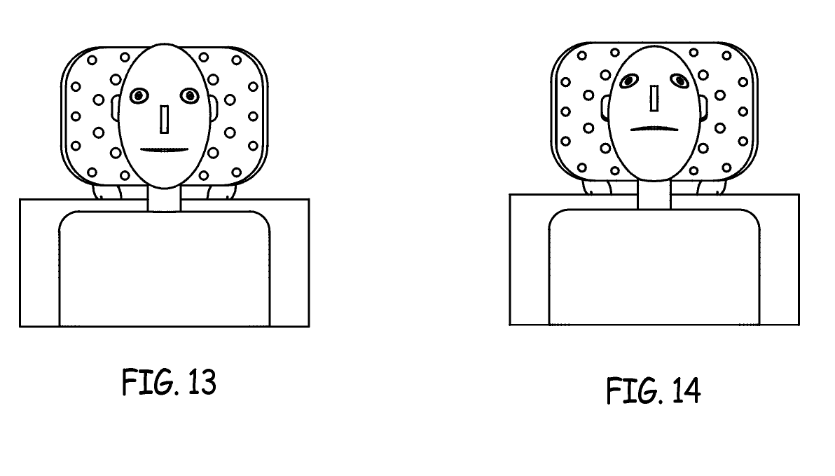

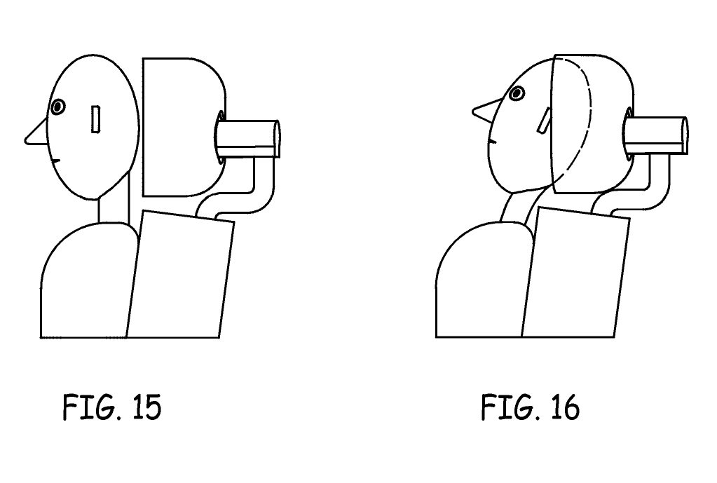

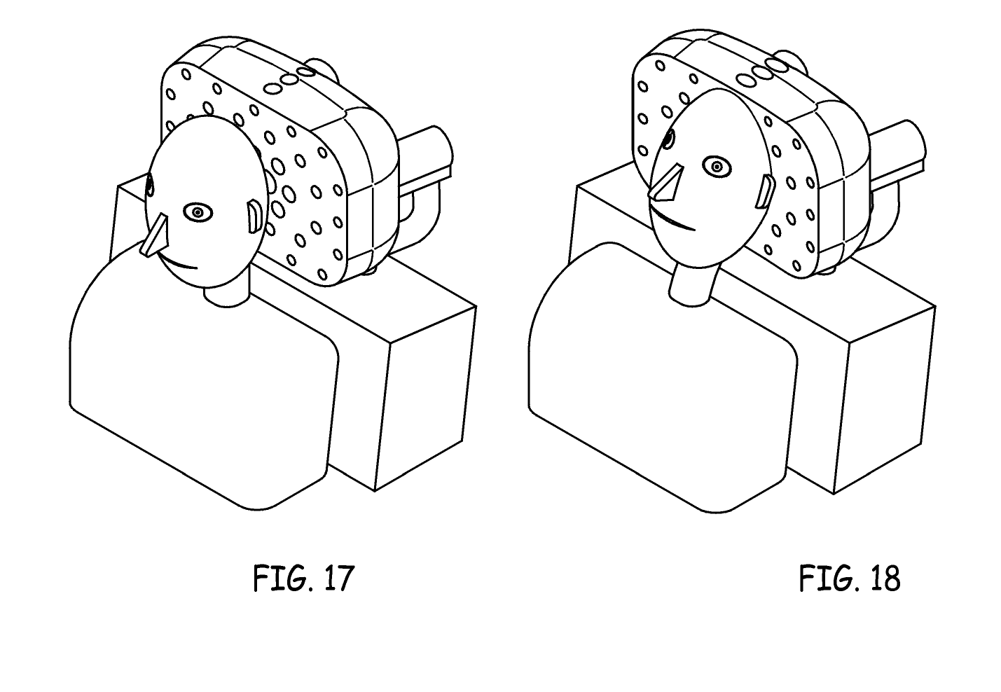

FIGS. 11-18 provide a series of front, lateral and diagonal side-by-side views to illustrate pre and post-impact views of the head position in relationship to the headrest invention's capacity of absorbing the impact and slowing the rebounding of the head forward. They are illustrations demonstrating the ability of the headrests of the present invention to absorb the forces causing a human's head and neck to propel backward and forward during a collision, such as a front or rear end collision. FIG. 11 is an overhead view before the collision in which the occupant's head is not touching or barely touching the headrest. FIG. 13 is a front view, FIG. 15 is a side view, and FIG. 17 is a front overhead perspective view of the pre-crash configuration.

FIG. 12 is an overhead view right after the collision when the occupant's neck and head are propelled backward into the headrest compressing the vertical channels 150. This compression enables the headrest to maximize its adsorption of impact forces generated on the headrest by the occupant's head. FIG. 14 is a front view, FIG. 16 is a side view, and FIG. 18 is a front overhead perspective view of the post-crash configuration.

### Packets

In other embodiments, the variable density of lower density toward the center and higher density toward the periphery can be accomplished, for a non-limiting example, by a lesser number of small gel, air or other type of small packets in the headrest's center and a higher number of such packets in the periphery.

### Layered Headrests

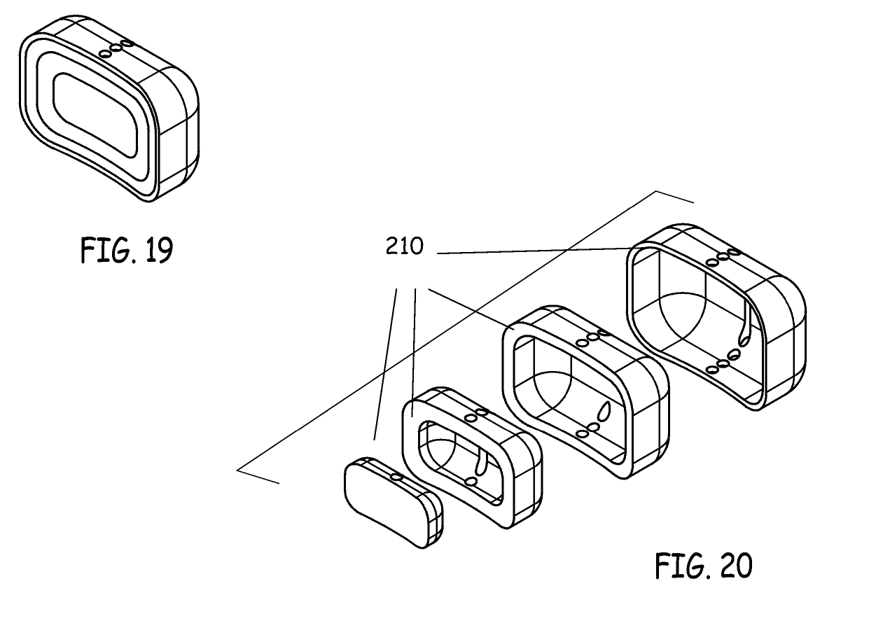

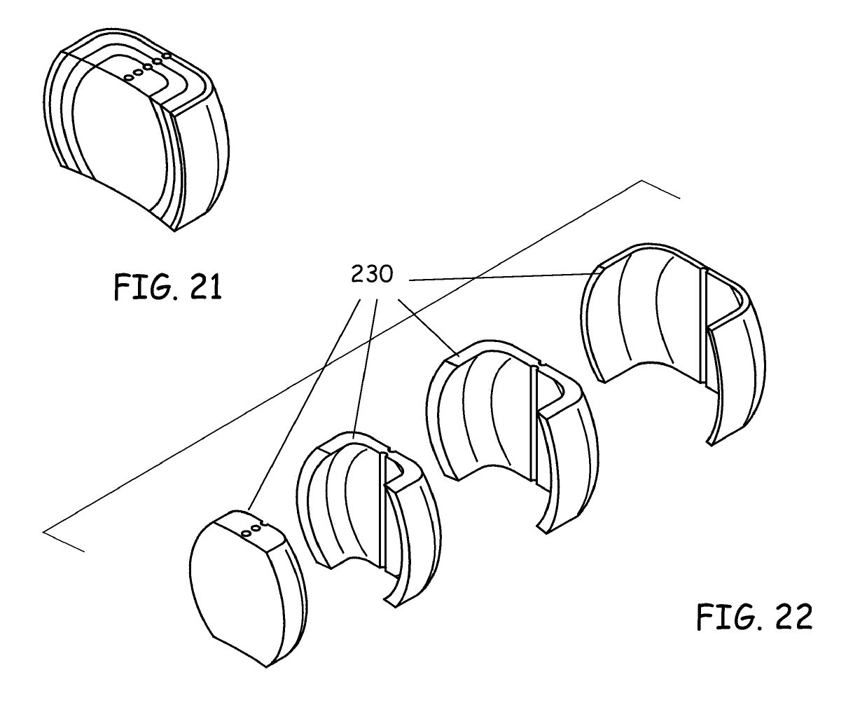

FIGS. 19-22 show how different density foams can be used in the headrest design in two different manners. As non-limiting examples of how such layers can be constructed, FIGS. 19 and 20 show one manner of layering, and FIGS. 21 and 22 show another. Both designs use the lowest density material in the center layers of the headrest for maximum absorption of impact and the material of the outer layers to be successively more dense to provide stability to the headrest structure. This design contains a series of holes in the center vertical plane of the headrest to allow the headrest to slightly “flex” to allow for the headrest's slight “gripping” effect. As described previously, the purpose of this gripping effect is to further slow the motion of the head forward.

FIGS. 19 and 20 illustrate one embodiment of the inside structure of the headrest comprising rectangular shaped layers within layers of impact absorbing materials. FIG. 19 is a front overhead perspective view; and FIG. 20 is an expanded view of FIG. 19 showing a breakout view of each of the exemplified 4 layers 210 of material. It is noted that the present invention covers a wide range of number of layers 210, such as from 2-8 layers.

### Gripping Effect

FIGS. 21 and 22 further illustrate embodiments of the disclosure's gripping effect by showing how in these embodiments the headrest is divided in 2 lateral pieces to allow for a certain amount of “elastic horizontal plane collapsing” of the headrest structure around the front occupant's head to slow forward motion of the head rebounding off the headrest. FIGS. 21-22 demonstrate the second embodiment of the inside structure of the headrest comprising semi-oval, semi-spherical, or “onion-shaped” layers within layers of impact absorbing materials. FIG. 21 is an overhead perspective view; and FIG. 22 is an expanded view of FIG. 20 showing a breakout view of each layer 230 of material. And although 4 layers are shown in the figures, the present invention covers a wide range of layers 230, such as from 2-8 layers.

### Four Impact Absorbing Apparatuses Attaching the Headrest to the Seatback

The following section show embodiments of the disclosure's redesign of the apparatus that attaches the headrest to the seatback, wherein the apparatus also functions to absorb impact in the case of a front or rear-end collision where the occupant's head is forcibly propelled into the headrest. There are four primary embodiments of the apparatus enclosed herein, although other impact absorbing apparatus's are envisioned within other embodiments of the disclosure. For any embodiment of the disclosure, the headrest may be raised or lowered to accommodate occupant size and comfort. The apparatuses provide increased absorption of the backward motion of the head into the headrest, and like an embodiment of the disclosure's unique structuring of the foam, allow for a much more gradual rebounding of the shock absorber means to its and the headrest's original position to prevent rapid rebounding of the head off of the headrest.

### C-Shaped Headrest/Seatback Shock Absorber

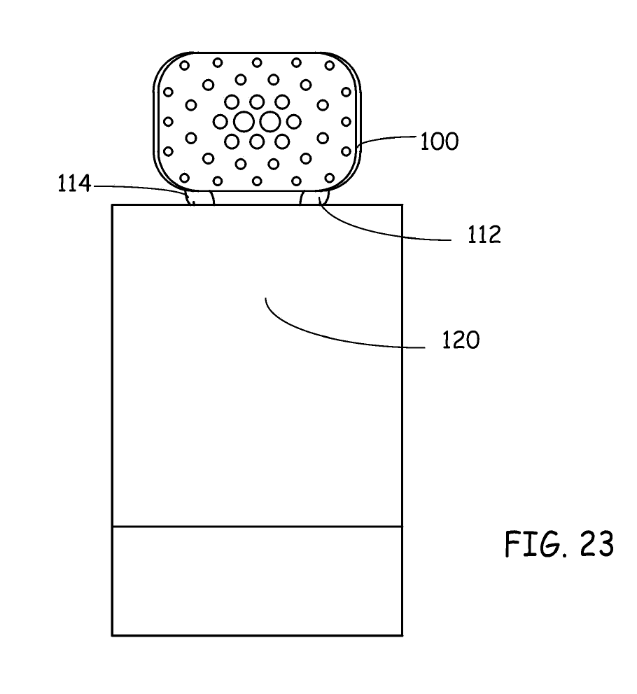

FIGS. 23-27, 28A and 28B illustrate a first embodiment where the shock absorption mechanism is positioned on the back of the headrest, and comprises an apparatus 110 with four points of connection (i.e. two to the headrest 100 and two to the top of the seatback 120) utilizing two identical or mirrored members (112, 114). The shock absorber means allows for backward movement of the headrest along the horizontal plane (x, z axis) to absorb impact forces (−z direction—backward) while diminishing opposing rebound forces (+z direction—forward) in order to slow the speed and the distance of the occupant's head/neck backward then forward movement (i.e. recoil).

The disclosure's headrest/seatback connection in some embodiments may be angled at greater than 90 degrees in the horizontal plane into the headrest. (This angling can be used in any embodiment of the disclosure, including those described below.) This horizontal plane angling accomplishes two things. First, in the C-shaped headrest/seatback shock absorber, it prevents the embodiment from extending too far back into the space of the back occupant. Secondly, if used in any of the other embodiments, it allows for a certain amount of “elastic horizontal collapsing” of the headrest structure around the front occupant's head to create an increased “gripping” of the occupant's head inside the headrest to slow subsequent forward motion of the head rebounding off the headrest.

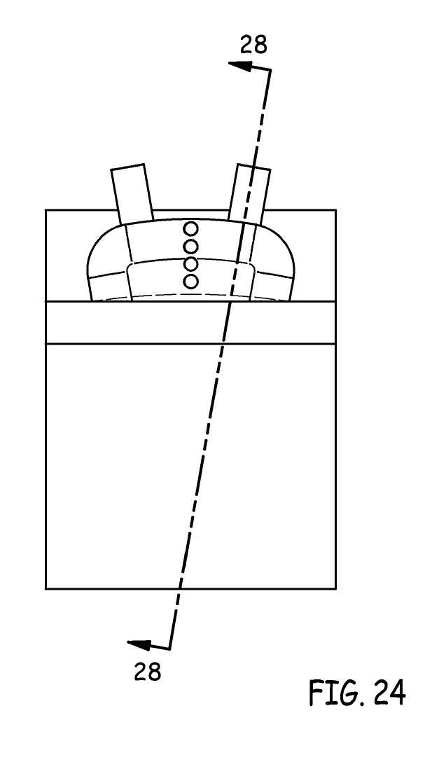

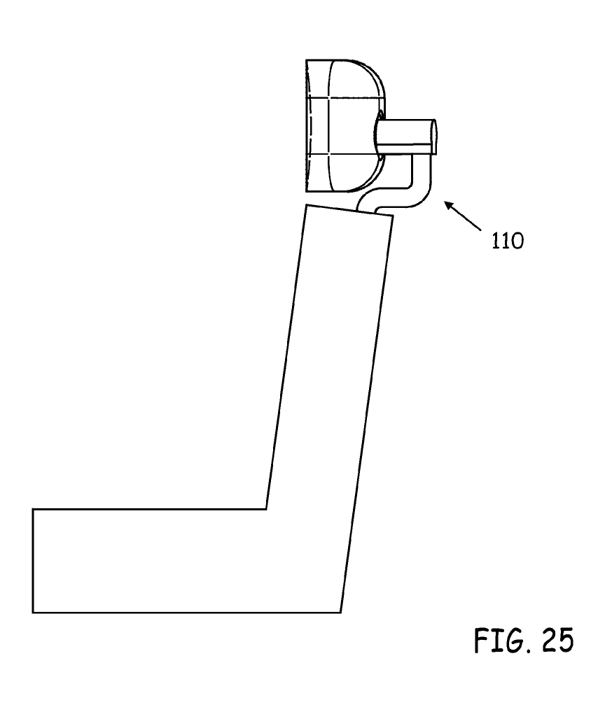

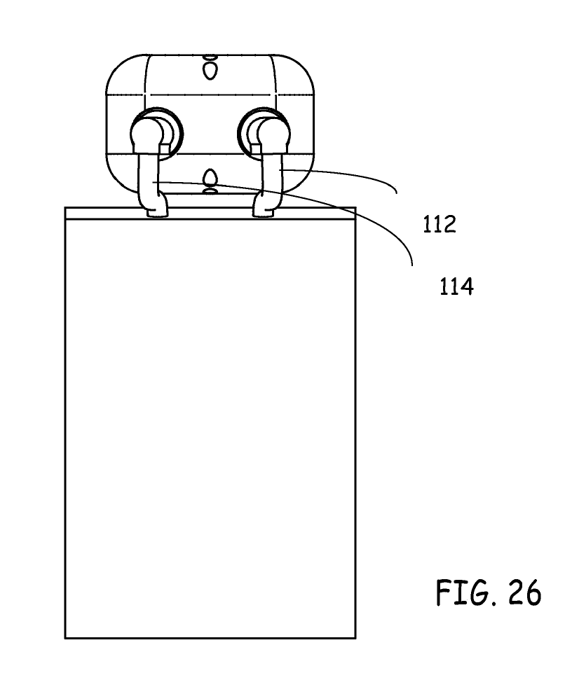

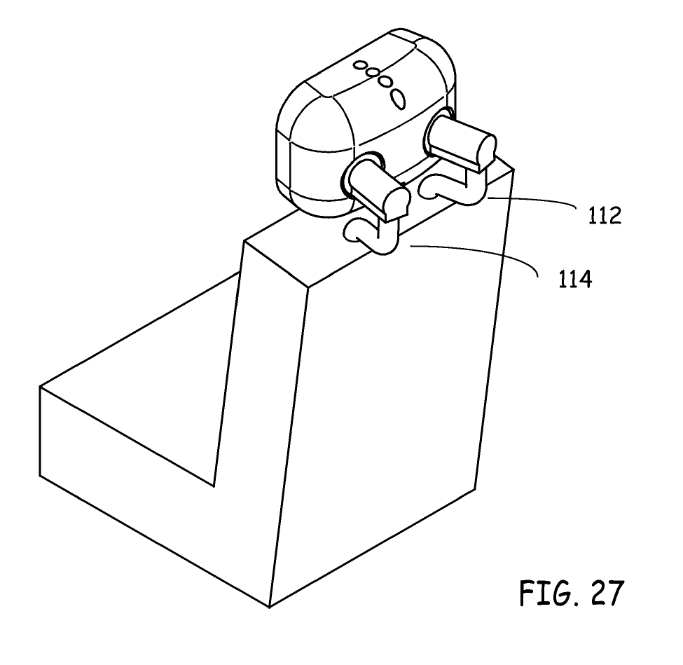

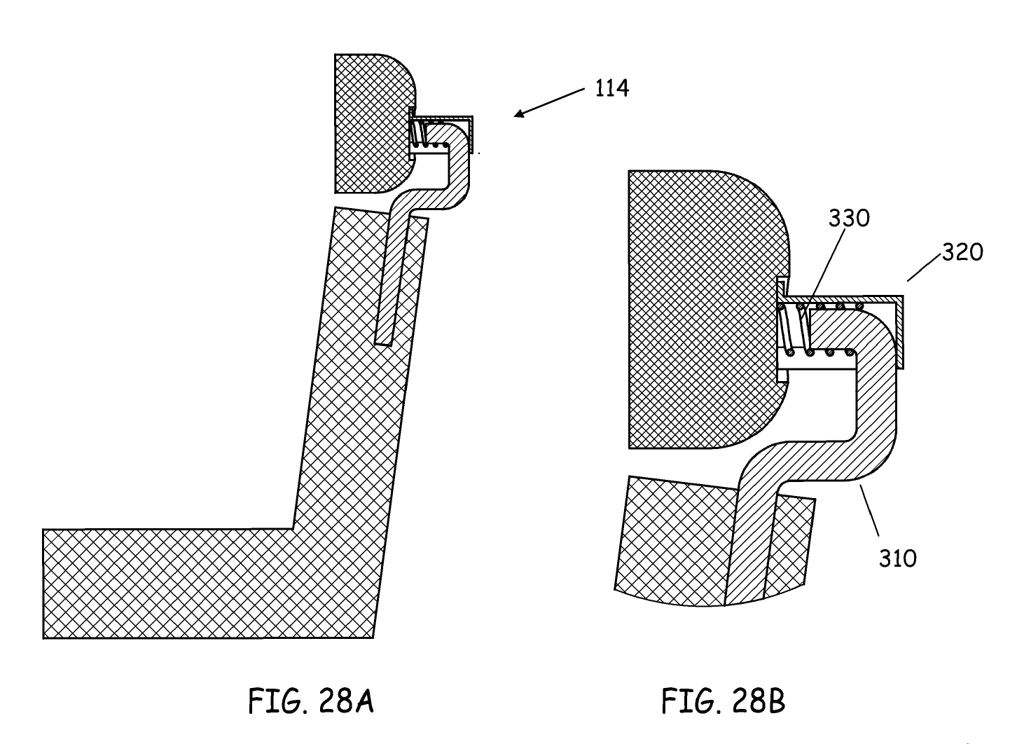

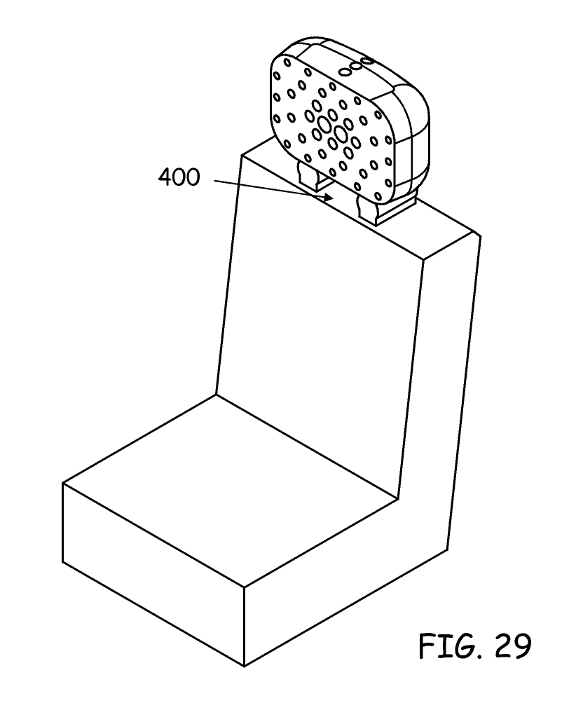

FIG. 23 is a front view of the “C-bar” apparatus embodiment; and, FIG. 24 is an overhead view showing a line (28) cut on the diagonal through a member 114 of the apparatus 110. (The line (28) represents the cross-sectional side view shown in FIGS. 28A and 28B). FIG. 25 is a side view of the “C” bar apparatus 110 affixing the headrest to the seatback. FIG. 26 is a back view of the “C” bar attachment affixing the headrest to the seatback showing the apparatus's member 112 and 114. FIG. 27 is an overhead perspective view of the back of the “C” bar attachment showing the apparatus's member 112 and 114.

FIG. 28A and FIG. 28B illustrate the cutaway section of FIG. 24. FIG. 28A is a cross-sectional side view of the “C” bar attachment affixing the headrest to the seatback using the apparatus member 114. FIG. 28B is a close-up view of the components of the member 114 (and thus also member 112), comprising a bent bar 310, a helical spring 320 attached between the bar 310 and the headrest to absorb the impact, and a cover 330 to protect the bar and spring assembly. Other shock absorber means may comprise air or oil-based shock absorbers that are used in a similar manner.

### Horizontal Headrest/Seatback Shock Absorber

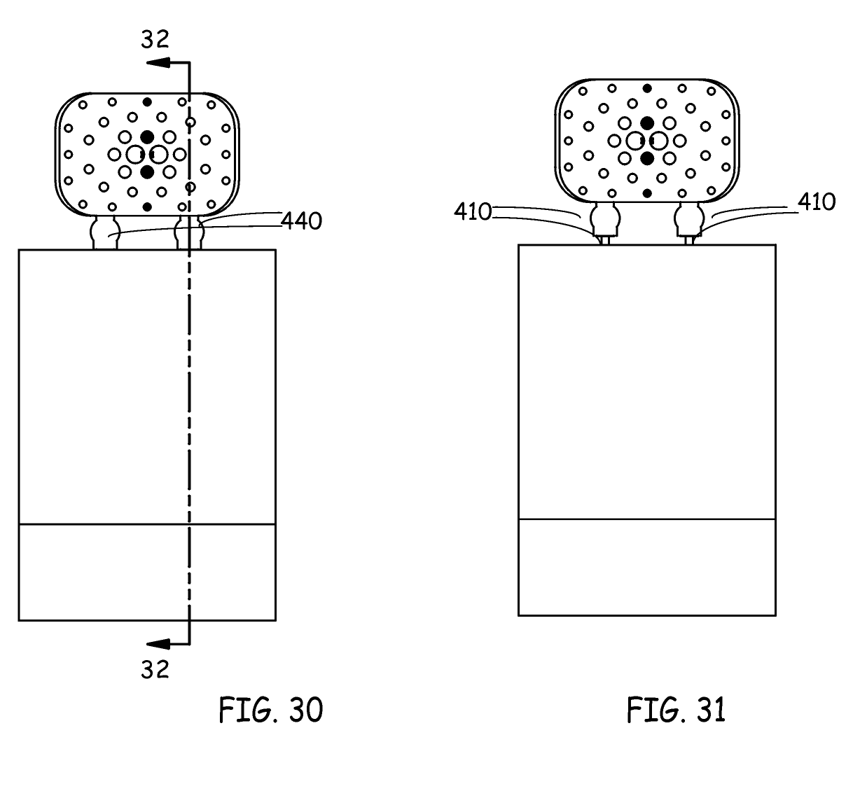

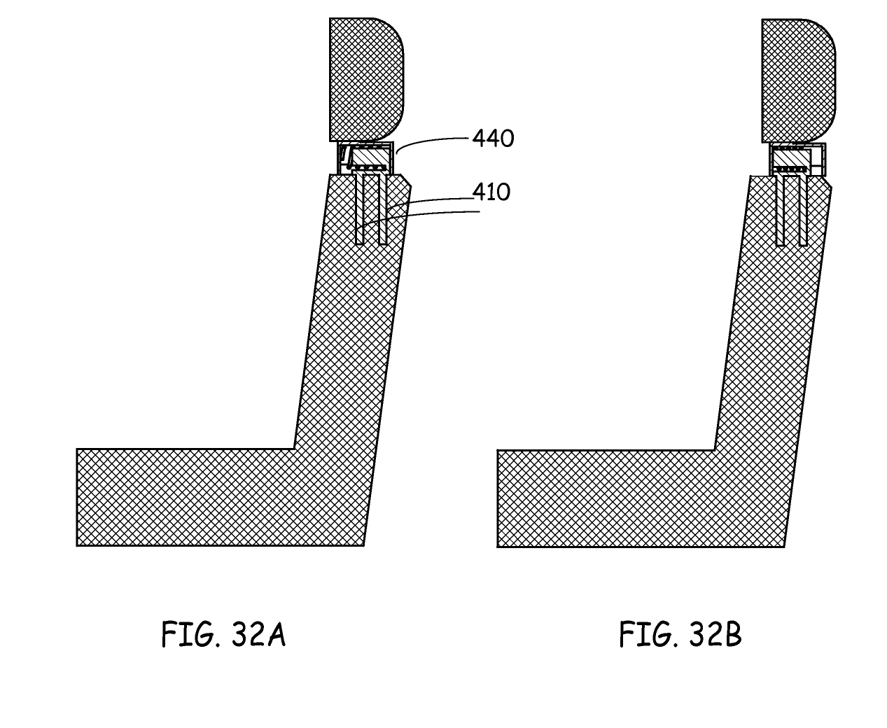

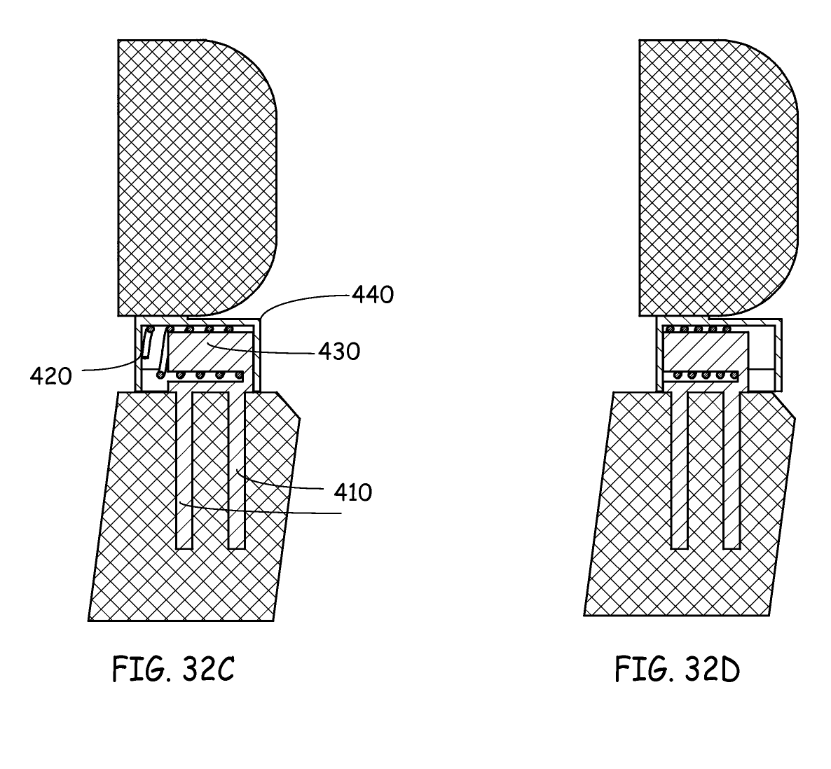

FIGS. 29-31 and 32A-32D illustrate a second embodiment of an attachment apparatus joining the headrest to the seatback. FIG. 29 is an overhead perspective view of headrest sitting atop the apparatus 400. FIG. 30 is a front view displaying the two covers 440 of the apparatus pushed down to hide the four rods 410 (see FIG. 31). FIG. 30 further comprises a line “32” representing the cross-sectional side view illustrated in FIGS. 32A-32D.

In this embodiment, the headrest is directly attached to the cylinder of the shock absorber means with the rods 410 extending into the seat. The shock absorber means may comprise a cylinder moving backward (as it does in the C-Shaped design). This horizontal headrest/seatback shock absorber means absorbs impact on the horizontal plane. Other shock absorber means may comprise air or oil-based shock absorbers that are used in a similar manner.

As further illustrated in FIGS. 32A-32D, the apparatus 400 sits between lower surface of the headrest and the top surface of the seatback, and attaches to the seatback via four vertical rods 410, comprising two rods aligned in the y, z-axis on the right and left side of the apparatus. The rods 410 reside below a cover 440 that houses a shock absorber means, such as one comprising a helical spring 420 residing in front of a piston or cylinder or bar 430. This design is also positioned in the horizontal plane (i.e. the plane created by the x, z-axis) so as not to extend into the space of a backseat occupant (a possible problem with the C-Shaped design). Like the C-shaped design, the helical compression spring 420 allows for backward movement of the headrest along the horizontal plane (x, z axis) to absorb impact forces (−z direction-backward) while diminishing rebound forces (+z direction—forward) in order to slow or dampen the speed and the distance of the occupant's head/neck backward then forward movement.

### Torus Headrest/Seatback Shock Absorber

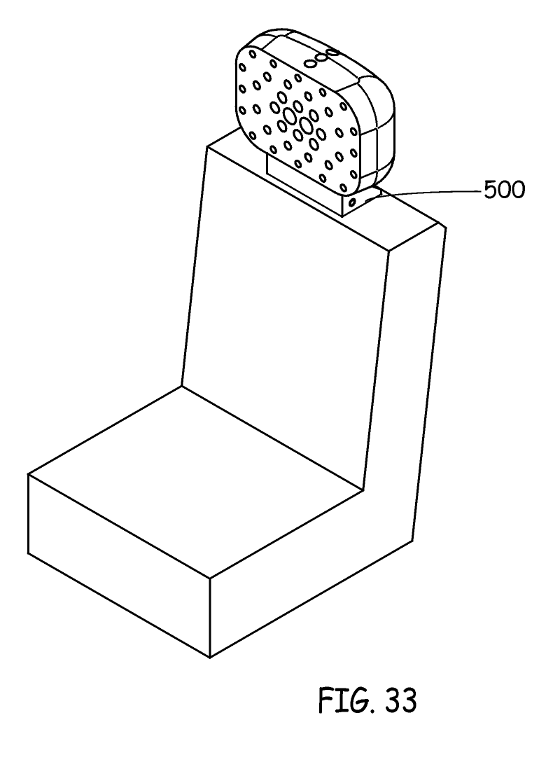

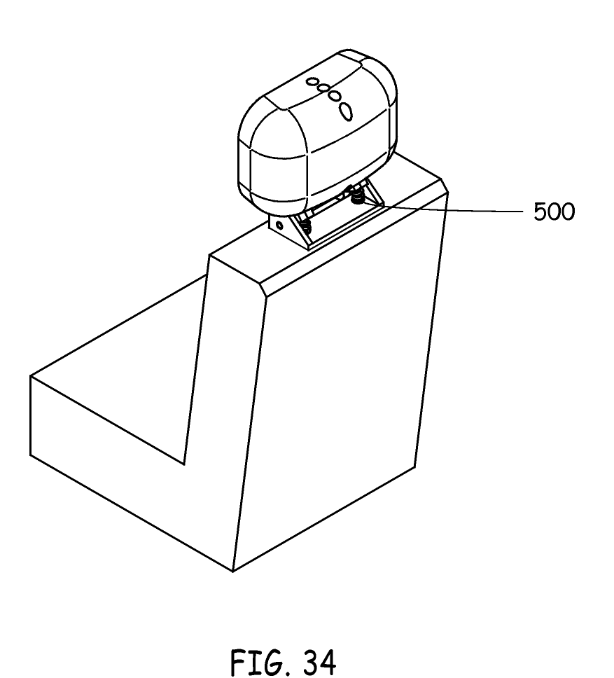

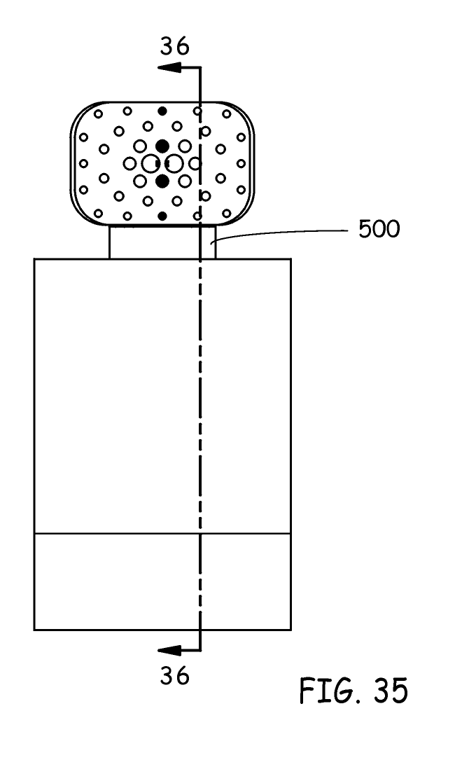

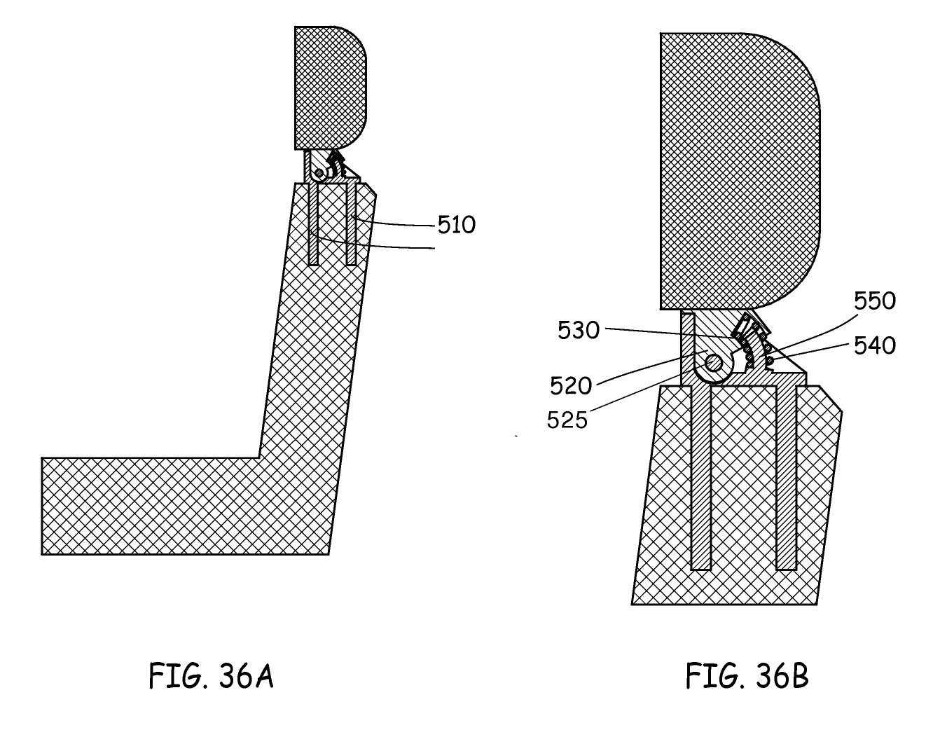

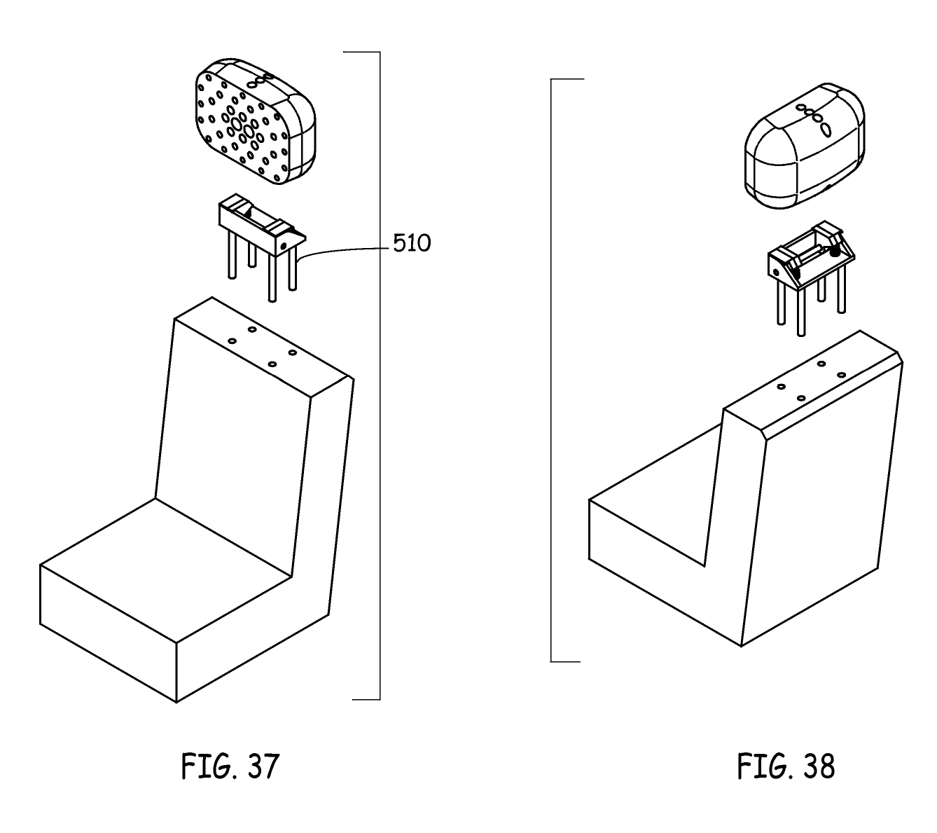

FIGS. 33-38 illustrate a third embodiment of the headrest/seatback shock absorber apparatus 500 of the present invention. FIG. 33 is an overhead front perspective view and FIG. 34 is an overhead back perspective view of the third embodiment. FIG. 35 is a front view with a cutaway section “36” further shown in the side cross-sectional views of FIGS. 36A and 36B. FIG. 37 is an expanded front perspective view showing the components of the headrest, apparatus 500, and the seatback; and FIG. 38 is a back perspective view of the same.

As illustrated in FIGS. 36A and 36B, the third embodiment comprises the apparatus 500 sitting between lower surface of the headrest and the top surface of the seatback, and attaching to the seatback via one to four vertical members (e.g. rods) 510, comprising two rods aligned in the y, z-axis on the right and left side of the apparatus. The headrest is directly attached to the lever 520 which has an internal torus 530 encasing the spring 540 (e.g. compression or torsional helical spring) and an external torus 550 encased by the spring. Internal torus 530 is attached to apparatus 500. Lever 520 can rotate around axis 525. Axis is attached to apparatus 500. This disclosure absorbs impact on both the horizontal and vertical planes. In alternate embodiments, air or oil-based shock absorbing mechanism can be used in a similar manner.

### Vertical Headrest/Seatback Shock Absorber Apparatus

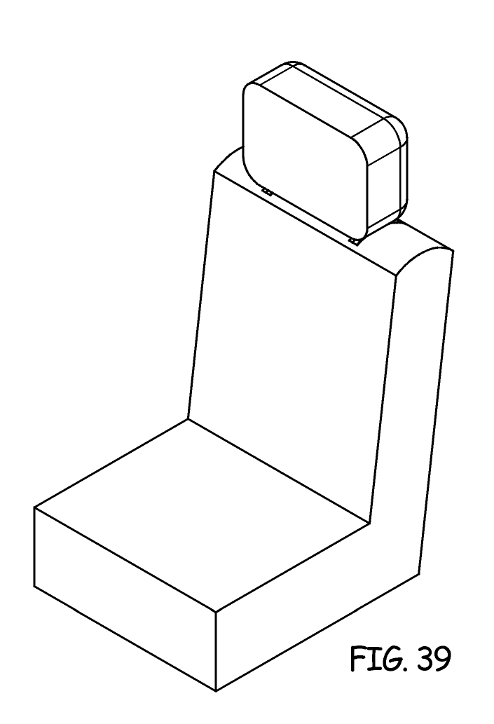

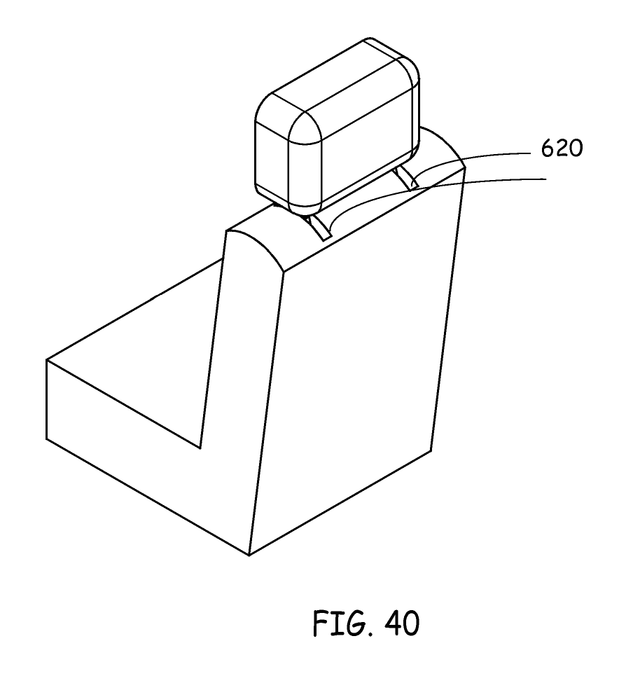

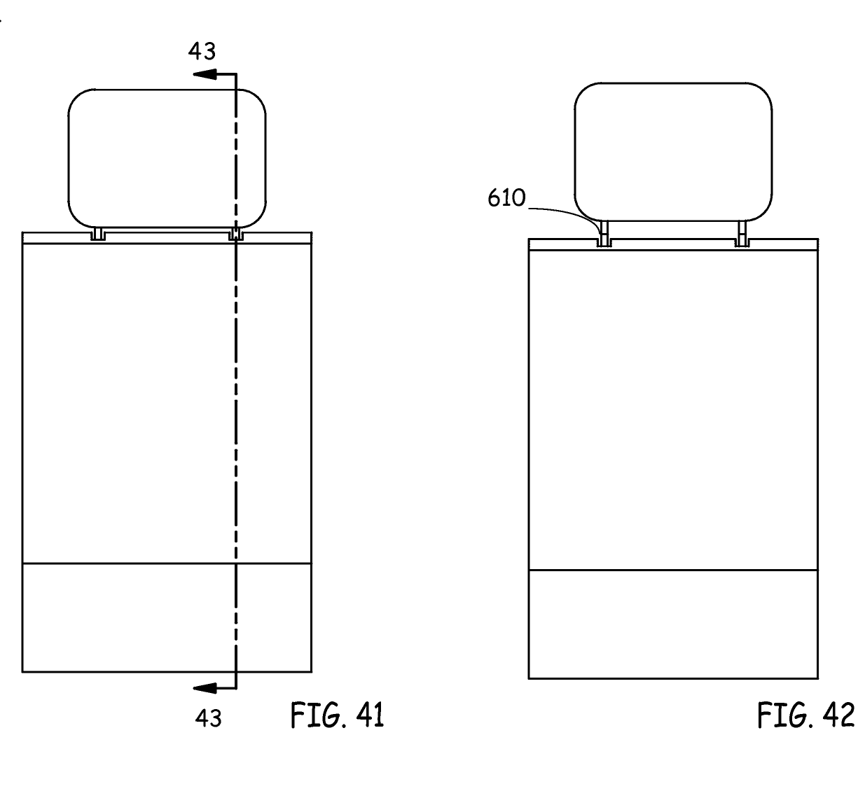

FIGS. 39-42 and 43A-43D illustrate the fourth embodiment of the headrest/seatback shock absorber apparatus 600. FIG. 39 is a front overhead perspective view of the seatback, apparatus 600 and headrest; and FIG. 40 is a rear top isometric view of the same. Slots 620 in the top surface of the seatback allow the headrest to tilt back upon sufficient impact of the occupant's head against the headrest. The top of the seat may be flat or convex and the bottom of the headrest may be either flat or concave to match the top of the seat. FIG. 41 is a front view of the headrest in a fully collapsed position wherein it resides flush with the top surface of the seatback. FIG. 42 is a front view of the headrest in a fully expanded position, thus exposing rod members 610 attaching the headrest to the seatback.

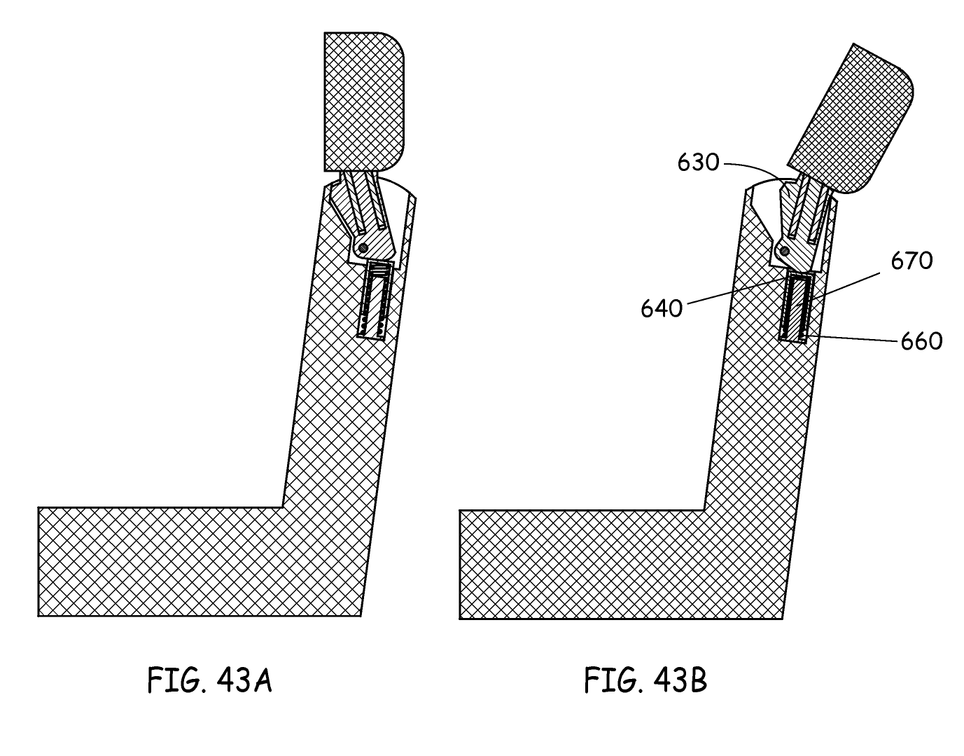

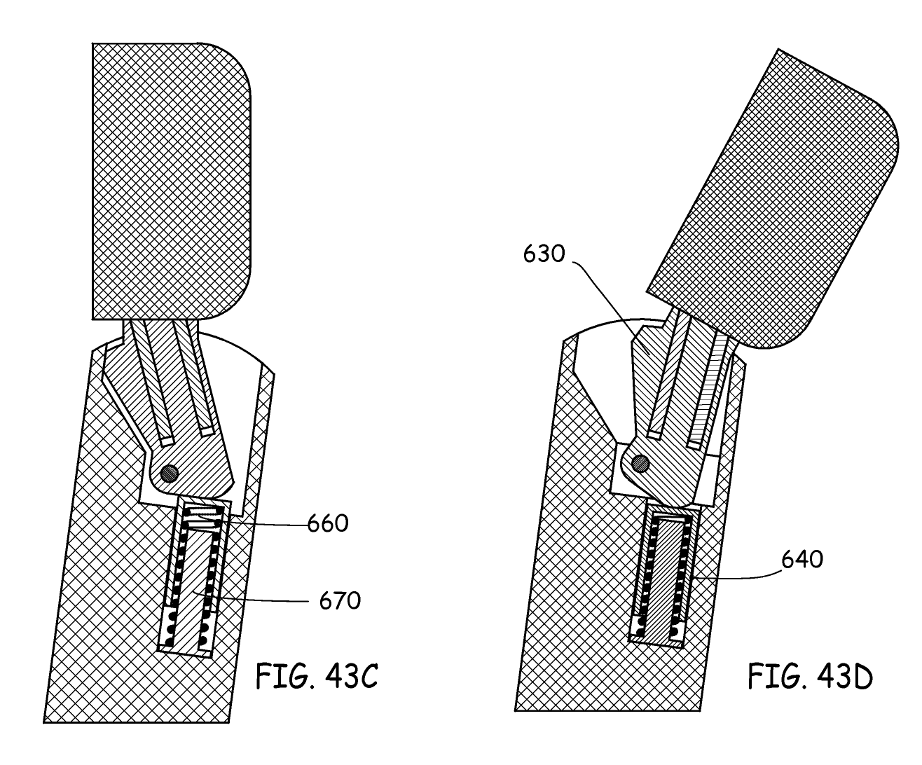

FIGS. 43A-43D illustrate a side cross-sectional view of the apparatus 600. FIGS. 43A and 43C show a cross-sectional view of the seat illustrating the front at-rest front position of the headrest. The headrest is attached via four rods 610 (i.e. two rods each aligned in the z-axis on the right and left side of the headrest). The rods are connected to a lever 630 with the ability to rotate around the x-axis.

FIGS. 43B and 43D show the rear position of the headrest, which results from sufficient impact of the occupant's head into the headrest causing rotation of the headrest and lever around the x-axis. The lower end of the lever 630 is constructed as a cam, which is in contact with the top of the cylinder 640 of a shock absorber. Inside the cylinder is a spring 660 seated on the rod 670 of the shock absorber. The cam activates the shock absorber by pushing the cylinder 640 down against the spring 660. When the spring is compressed, its diameter expands and contacts the inside surface of the cylinder 640. The friction between the spring and the cylinder will slow the movement of the cylinder down and thus slow the movement of the entire headrest backward.

Subsequently and as illustrated in FIGS. 43A and 43C, the friction between the cam and the top of the cylinder 640, as well as friction between the expanding spring 660 and the rod 670, slows the headrest's movement back to the front resting position to prevent propulsion of the occupant's head into the airbag. This vertical headrest/seatback shock absorber invention absorbs impact on both the horizontal and vertical planes.

In another embodiment of this vertical headrest/seatback shock absorber invention (not illustrated) using a regular type of shock absorber with a spring and cylinder containing oil or air, the slowing down of the backward and forward motion will occur when oil or air is pushed through the small holes between the two halves of the cylinder 640.

### Seatback

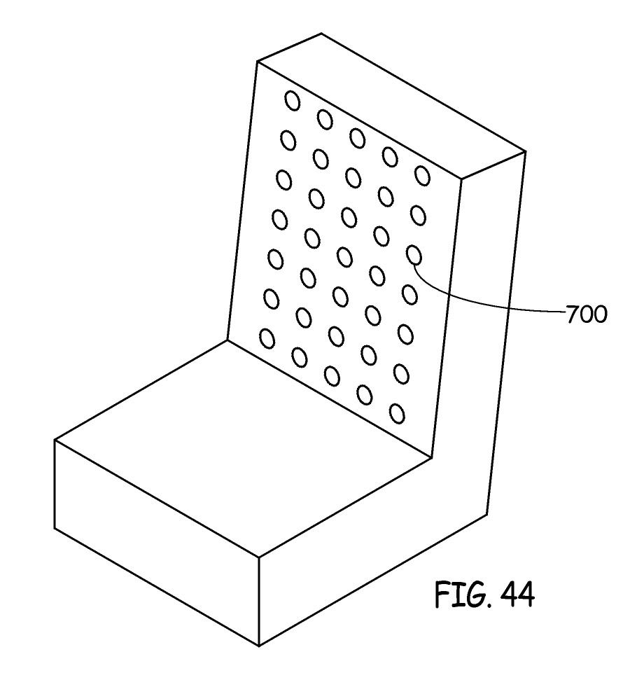

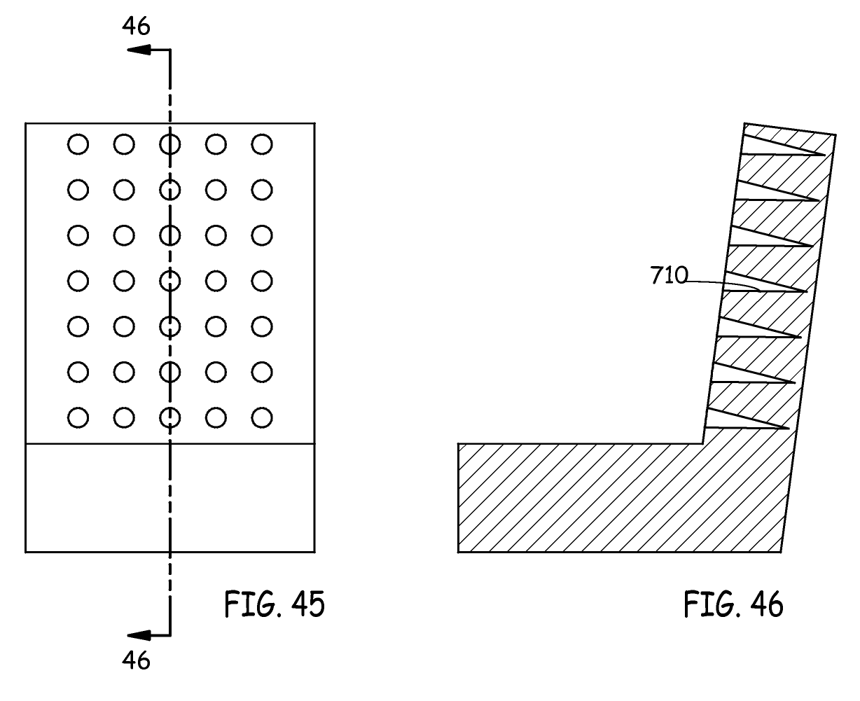

The present invention further comprises impact absorbing features in the front seatback. FIGS. 44-46 illustrate an embodiment of a sample conical hole arrangement in the seatback's structure for an increase of impact absorption. Similar variations of types, size, direction and lengths of holes or arrangements of multi-density foam, gel or other materials as described in embodiments of the disclosure's headrest design can be employed in various embodiments of the seat back for increase impact absorption capacity. FIG. 44 is an overhead front perspective view displaying holes 700 in the front surface of the seatback. The holes extend from the seatback's front surface to the back surface with decreasing diameter to form a conical channel through the seatback. The channels may penetrate the back surface or not. FIG. 45 is a front view of the seatback with holes displaying a cutout line “46” showing the view for FIG. 46, which comprises a side cross-sectional view of the seat with conical holes 710 extending almost through the seatback. When the occupant is forced into the seatback upon a collision, the conical channels enable the seatback to compress and absorb the impact forces.

### Seat Tilt Mechanisms

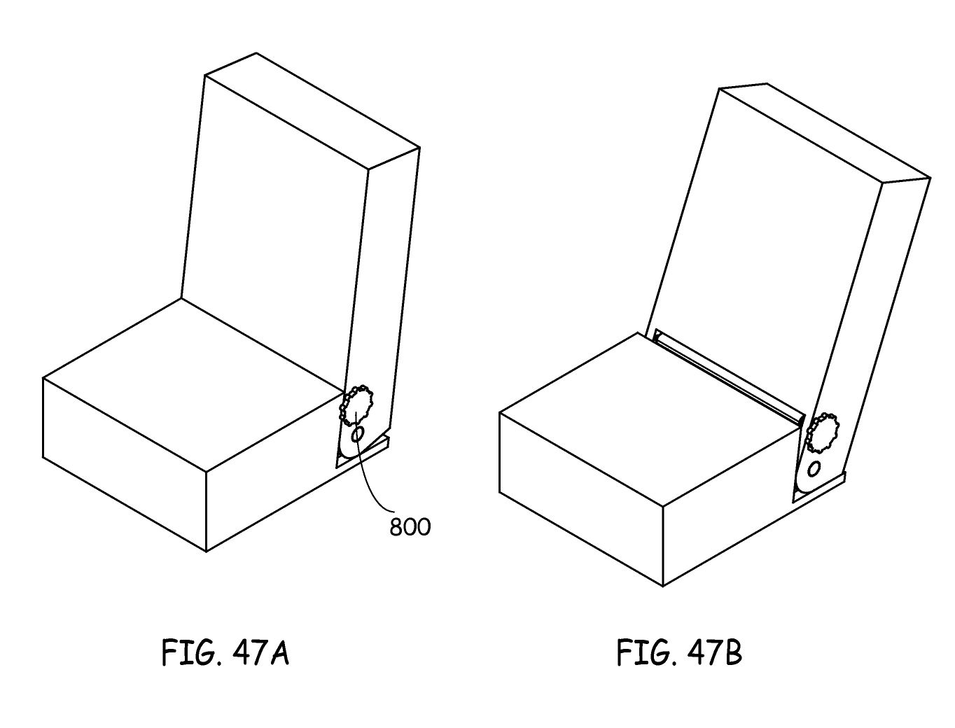

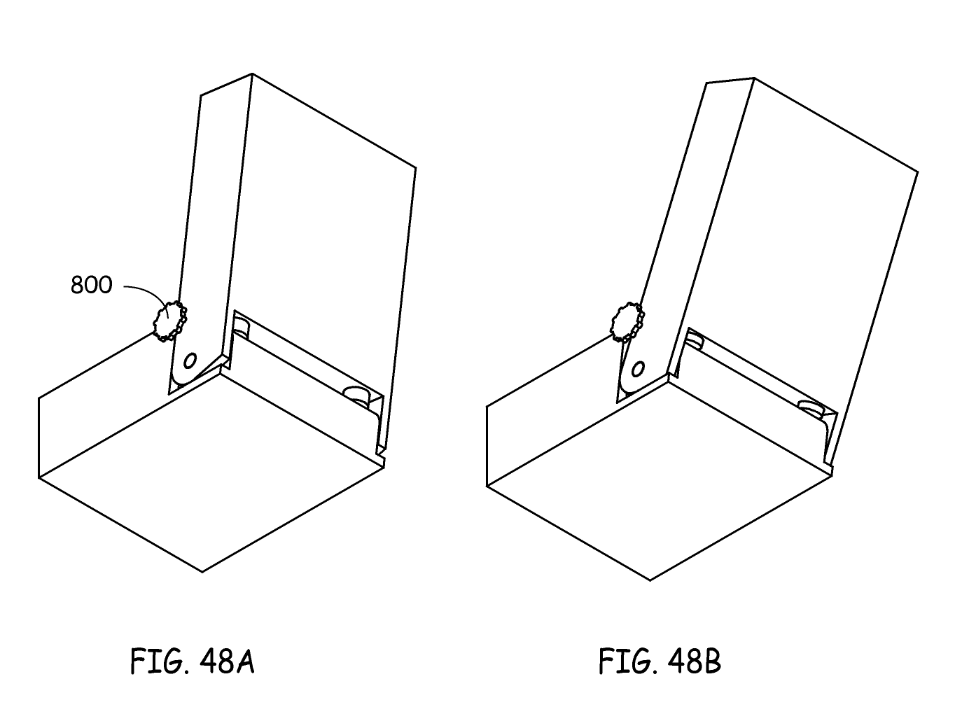

FIGS. 47A, 47B, 48A, 48B, 49A, 49B, 50A, 50B and 51A-51D depict embodiments of the disclosure's flexible locking (e.g. seat backward/forward tilt) mechanism compared to the standard non-flexible mechanism of prior art systems to control the occupant-determined angle of the seat back. The flexible locking mechanism would be set to provide for a similar type of minimal yet vital increase of the seatback's backward motion in the case of a front or rear impact collision compared to the rigid holding of the seatback joint of prior art systems' seatback adjustment mechanisms.

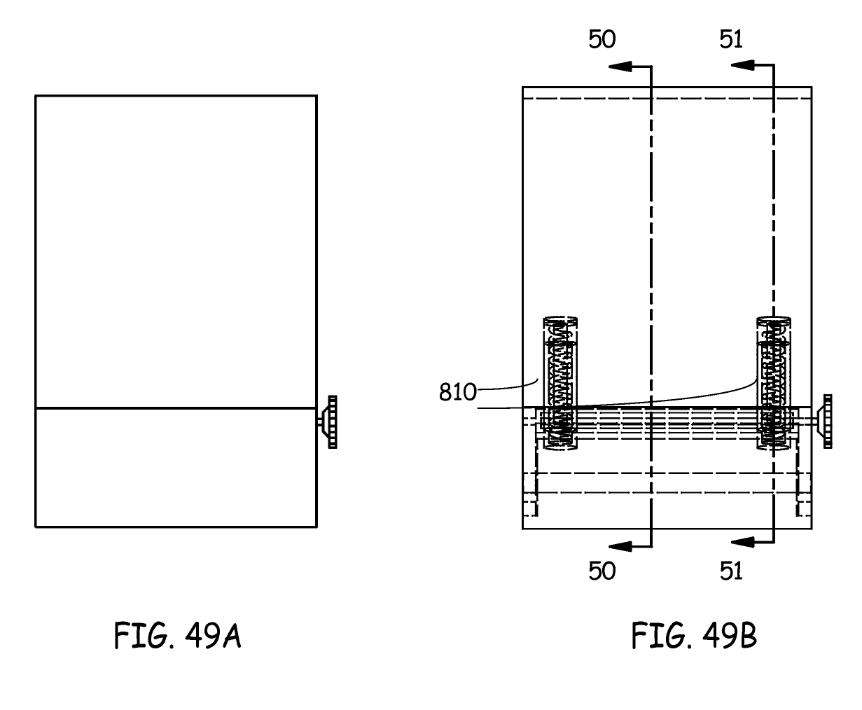

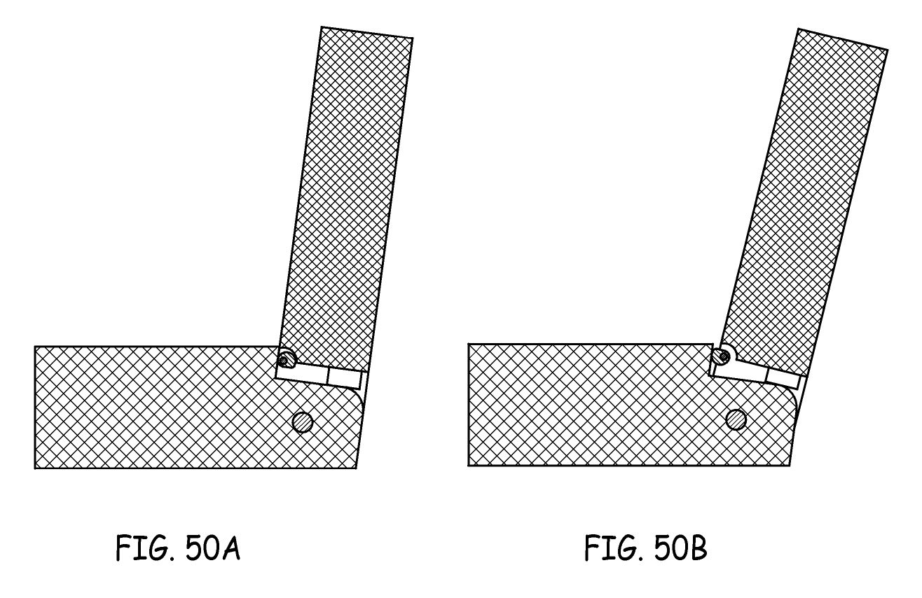

In all FIGS. 47 through 50, the “A” figures represent the pre-impact front position of the seat, and the “B” figures represent the post-impact rear position of the seat. FIGS. 47A and 47B are door side, front, overhead perspective views of the driver's seatback with a tilt adjustment knob 800. FIGS. 48A and 48B are door side, back underside perspective views the tilt knob 800. FIG. 49A is a front view of the seat with means to absorb movement of the back of the seat in relation to the bottom of the seat during rear impact. FIG. 49B is the front plan view of the seatback displaying the internal spring loaded components 810 of the seatback tilt mechanism. FIG. 49B further comprises the cutaway line “50” further illustrated in FIGS. 50A and 50B, and representing the side cross-sectional view through the middle of the seatback.

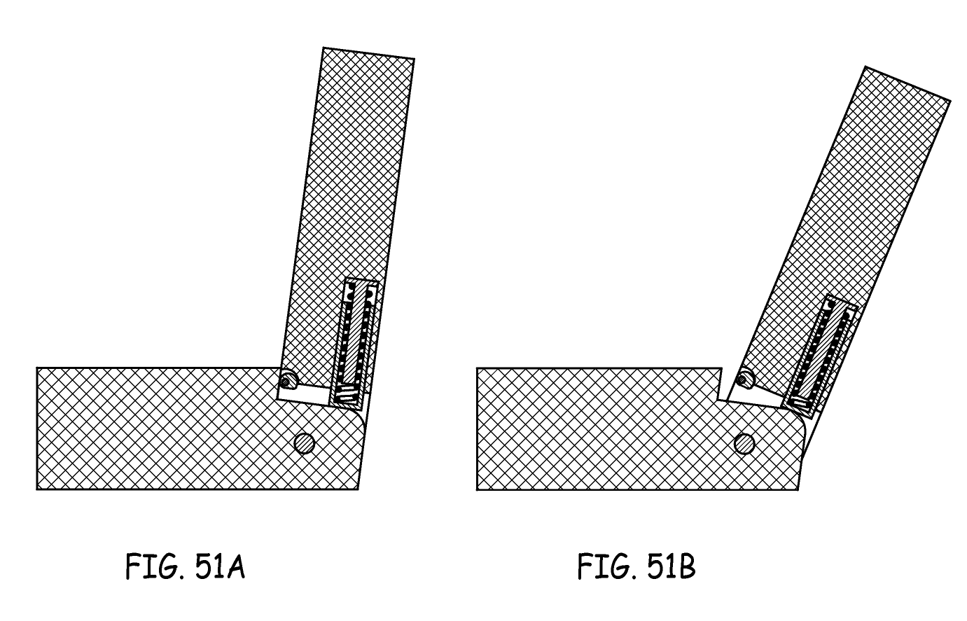

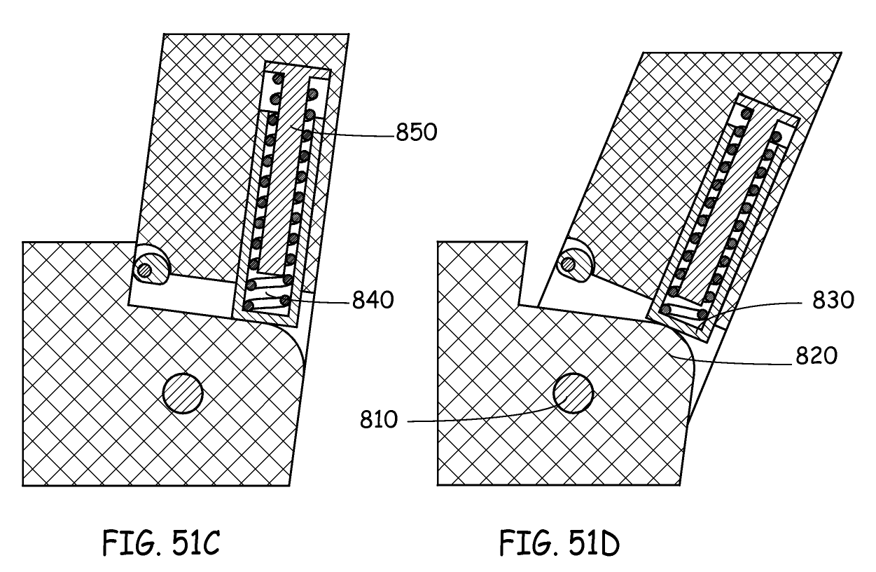

And FIG. 49B comprises the cutaway line “51” representing the side cross-sectional view through the left side spring loaded mechanism 810. FIG. 51C is a close-up of the 51A pre-impact front position of the seat and FIG. 51D is a close-up of the 51B post-impact rear position of the seat.

The post-impact rear position of the seat results from sufficient impact of the occupant's back into the seatback causing rotation of the seatback around the horizontal x-axis attaching the seatback to the seat bottom. As illustrated in FIGS. 51C and 51D, the seat bottom has a cam 820 which is in contact with the bottom of the cylinder 830 of the shock absorber. Upon impact, the cam pushes the cylinder down against the spring 840. When the spring is compressed, its diameter expands and contacts the inside surface of the cylinder. The friction between the spring and the cylinder will slow the movement of the cylinder down and thus slow the movement of the entire seatback backward. In the return movement to the front pre-impact position (FIGS. 51A and 51C), the friction between the cam and the bottom of the cylinder, as well as friction between the expanding spring and the rod 850, will slow the movement down to prevent propulsion of the occupant's body toward the airbag.

In other sample embodiments (not illustrated) the disclosure may use a regular type of shock absorber with a spring and cylinder containing oil or air. Slowing down of the backward and forward motion of the seat tilt will occur when oil or air is pushed through the small holes between the two halves of the cylinder.

### Attachment of Seat Bottom to Vehicle Floor

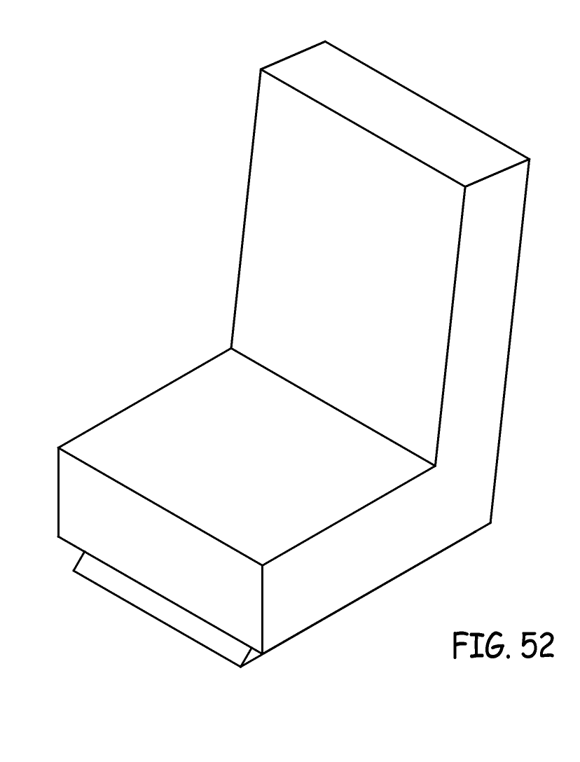

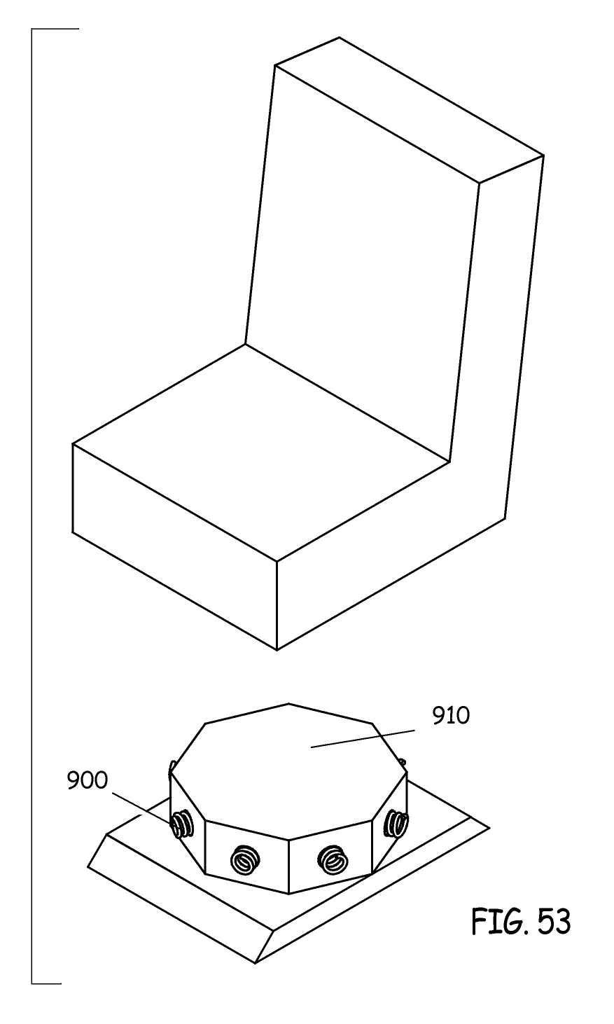

This aspect of this embodiment of the disclosure allows absorption of impact when the vehicle is impacted from any direction (as opposed to the primarily front or back collision impact absorption mechanisms associated with embodiments of the disclosure's headrest design). FIGS. 52 through 56 illustrate a sample embodiment where a number of springs 900 (or, in alternate embodiments, shock absorbers) are placed on the horizontal plane to absorb impact from any direction without overly displacing the seat where it would collide into the door, steering column, dashboard or back occupant's knees. In the sample embodiment an octagonal shaped housing is illustrated to house 8 springs positioned in 8 separate quadrants. Other embodiments may use a circular housing or another shape, and use more or less springs or shock absorbers.

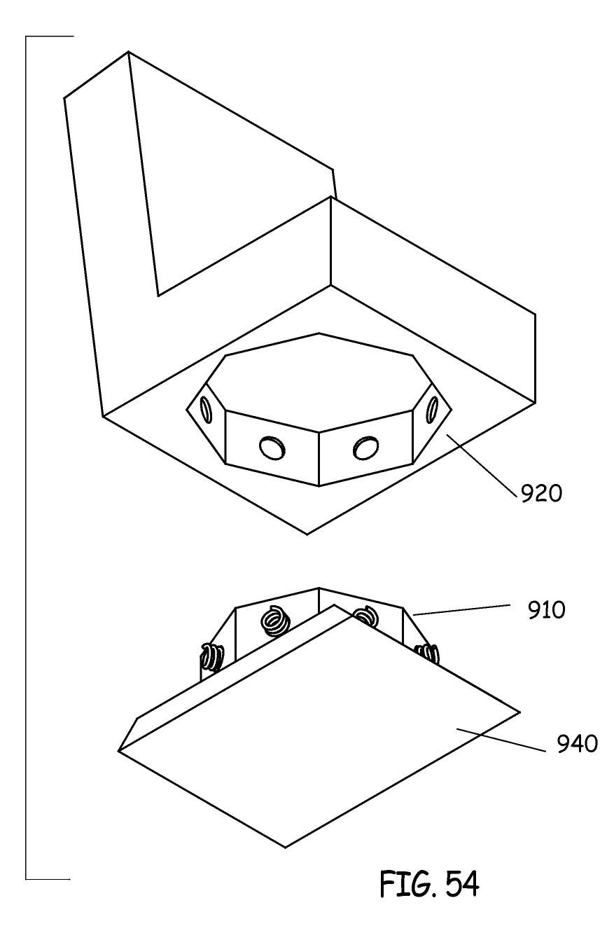

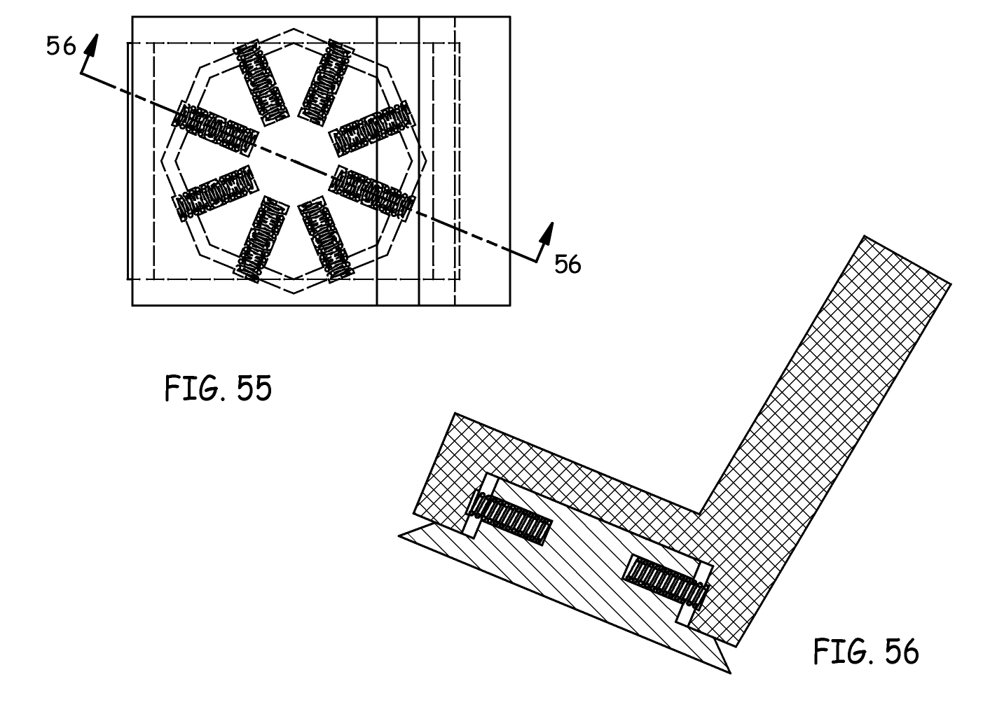

FIG. 52 is an overhead front perspective view. FIG. 53 is an expanded overhead perspective view of FIG. 52 showing an octahedral shaped male member 910 with 8 torsional springs 900 extending perpendicular to the male member. FIG. 54 illustrates one means of attaching the seat to the floor of the vehicle comprising a male member 910 with two or more evenly spaced fixation devices (e.g. springs 900) that fit into holes on the female member 920 located on the underside of the seat. The torsional springs 900 are evenly spaced around the male member 910 to absorb shearing and compressive forces resulting from a collision from any direction (e.g. broadsided). Additionally, the male member is attached to the floor directly or via another member 940. FIG. 55 is a bottom view of the undersurface of the male member of the attachment with a cutaway “56” shown in FIG. 56, which is a cross-sectional side view of the embodiment.

### Seatbelt

### Material Layers

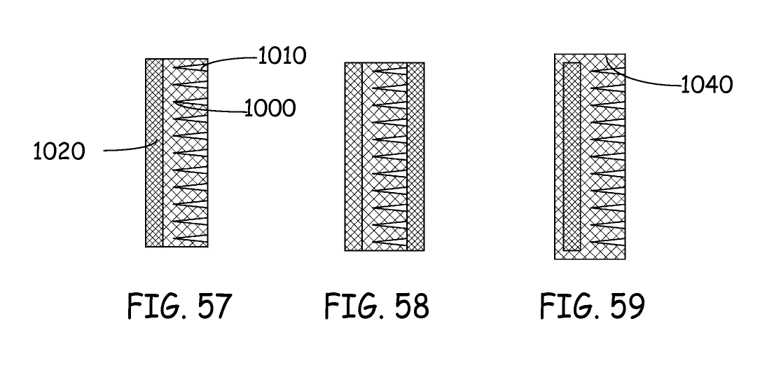

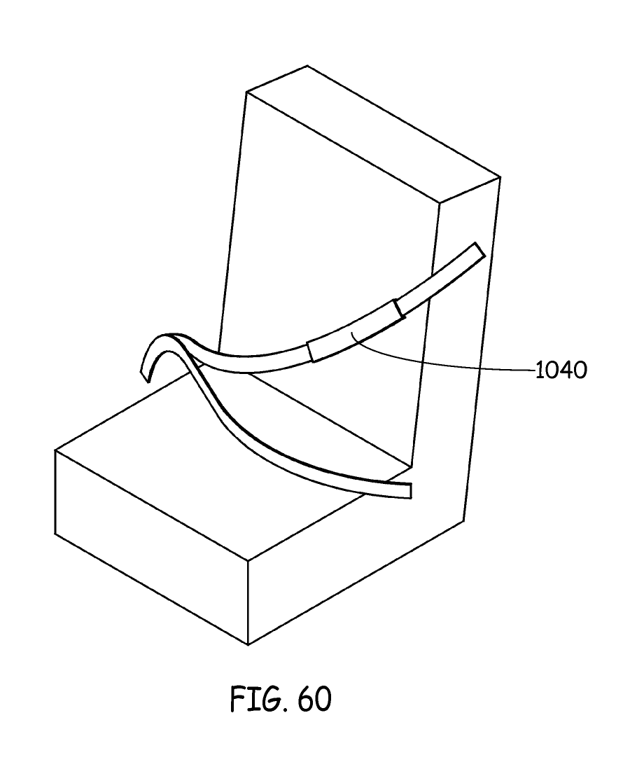

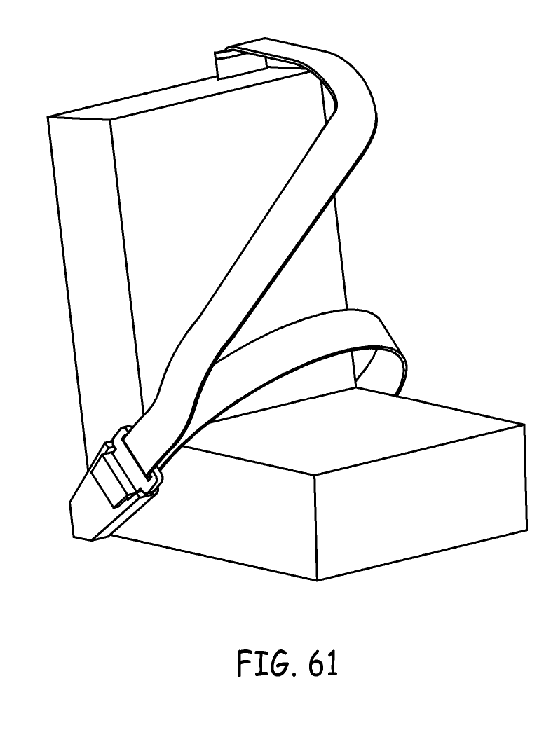

FIGS. 57-59 depict a conical-shaped hole design in a foam or gel layer of the seatbelt (as non-limiting examples of materials that can be used). This conical shaped hole design was described in the description of the headrest and seatback design. Similarly, memory foam or a gel, foam or some other absorptive substance can be encased between two outer layers of the seat belt. FIG. 57 illustrates a sample embodiment where the foam material 1000 comprising conical channels 1010 is directly in contact with the occupant on the right side and connected to the belt 1020 on the left side. FIG. 58 illustrates the foam material encased between two outer belt layers made of the flexible weave material described below. FIGS. 59 and 60 illustrate the foam material made as a moveable sleeve 1040 surrounding the belt. This sleeved seatbelt can be attached either to the car body or shoulder strap as is currently the standard used in vehicles (FIG. 60), or it can be used in seatbelts that are attached only to the seat as illustrated in this invention (FIGS. 61-63).

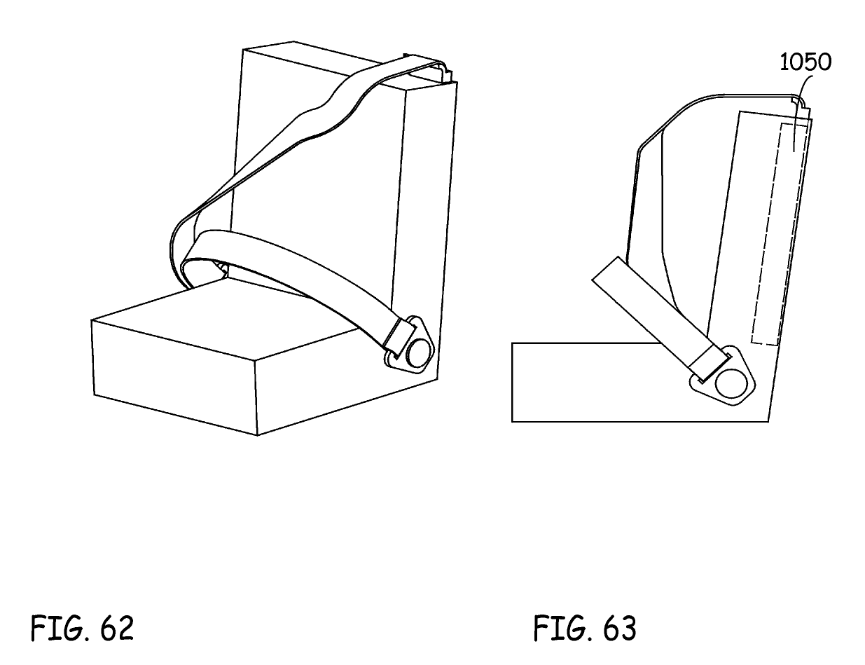

FIGS. 61-63 illustrate the seatbelt attached to the seat at three points of contact, versus the floor of the vehicle. The three points of contact are: on both the right and left sides of the seat bottom, as well as on the top or back of the seat near the window (e.g. slightly behind the occupant's shoulder facing the window). FIG. 61 is a right perspective side view of the seat with the seatbelt showing the buckle attached to the seat; FIG. 62 is a left perspective side view of the seat with the seatbelt; and FIG. 63 is a side view of the seat with the seatbelt showing the shoulder strap attached to the back of the seat with a mechanism 1050 for expanding and retracting the seatbelt.

FIGS. 61-63 represent the seatbelt of the present invention wherein all 3 points of contact are to the seat, versus the car body. The purpose of this is to retain the occupant to the seat rather than to the car body. This allows embodiments of the disclosure's multiple impact-absorbing mechanisms to be maximized by allowing the occupant's body to move with the slightly mobile seat rather than being jarred by being attached to the immobile car body i.e. immobile in relationship to the seat). The 3 points of contact are: 1) the shoulder strap which is attached to near the top of the left side of the driver's seat; 2) the waist strap which is attached to the left side of the seat bottom; and 3) the opposite end of the seatbelt strap comprising straps (1) and (2) merged together, which is attached to the right side of the seat bottom via a seat buckle. It is understood that the seatbelt of FIGS. 61-63 represents seatbelts for the seats on the left side of the vehicle, and that seats on the right side of the vehicle would have opposite sides of attachment to the seat bottom and sides.

FIG. 63, 1050 depicts a variable retraction/extension mechanism that allows for a tiny bit more play than the standard seatbelt. The shoulder strap's point of attachment is to the seatback top surface wherein it slides back and forth beneath a fixed guide, and the remainder of the belt is housed within the member 1050 residing vertically in the seat back. This permits the belt to retract out and in as the occupant is shifting, rotating, snapping, or unsnapping the belt, and it provides some extension of a few inches during impact collisions wherein the occupant is thrown slightly forward. In concept, this would work similar to the variable tension mechanism used in fishing reels. Regarding fishing reels, without this variable tension mechanism that allows a larger fish to pull slightly backwards against the line, the line would often break. Similarly, by creating a variable tension mechanism in a seat belt that would allow for a small amount of higher-tension play before the seatbelt locked, soft tissue injury can be decreased without losing the seatbelt's life-saving retention capacities that prevent the body from propelling forward.

### Weave

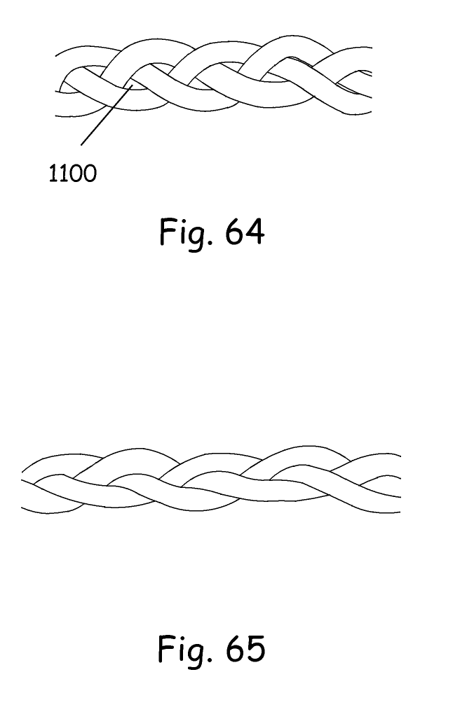

FIGS. 64 and 65 illustrate a slightly flexible weave used in embodiments of the disclosure's seatbelt fully or with sections of the belt containing weave material. This weave will function similar to the manner in which climbing rope is weaved to allow for “bounce” when a climber falls. Upon a climber falling, this flexible weave prevents the jarring high impact and higher potential for injury that would be caused by a non-flexible rope weave. A similar attenuation of high impact forces occurs in embodiments of the disclosure's seatbelt design.

FIG. 64 depicts a sample embodiment of the loose type of weave design that could be used in an embodiment of the disclosure. The spaces 1100 between the fibers close (FIG. 65) when the occupant is propelled forward in the case of impact, lengthening the entire seatbelt and thus absorbing a portion of the impact.

Different embodiments of the seatbelt may be made with 100 percent of this flexible weave material. Other embodiments may contain this weave only in the center section of the seatbelt where it comes into contact with the occupant's shoulder, as a non-limiting example. The purpose of having this flexible weave design in only certain sections of the seatbelt would be to limit the elasticity of the belt depending upon how much a certain manufacturer might determine would be optimal given that the seatbelt will still need to constrain the occupant from propelling forward.

Rather than the flexible weave design depicted, other embodiments of the disclosure may use other types of flexible materials such as rubber in either the full seatbelt or sections of it.

Even just a small section of additional play in the seatbelt would be an improvement of the zero-play design of prior-art seatbelt designs which can create injury to the shoulder, neck and body because of this lack of flexibility.

### Airbags

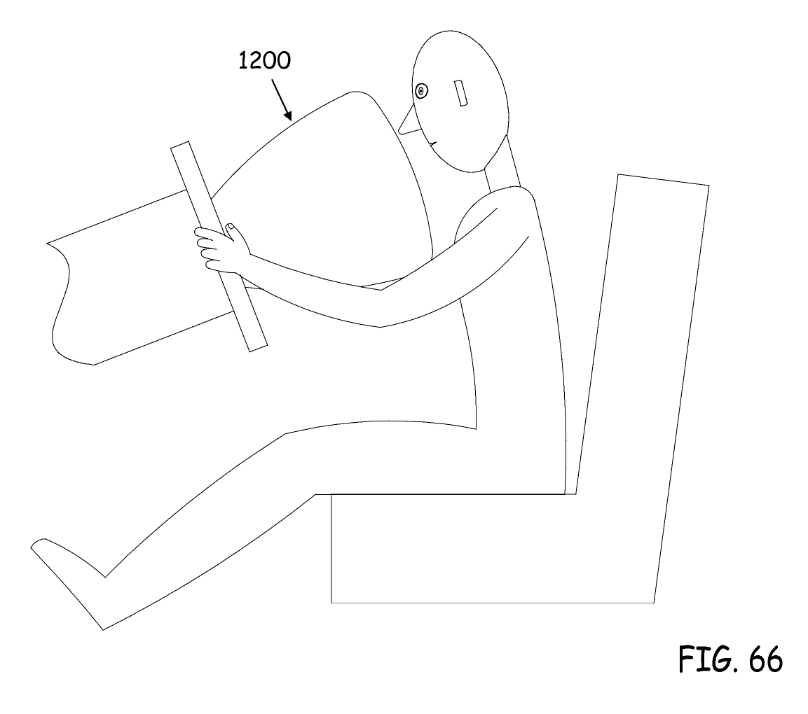

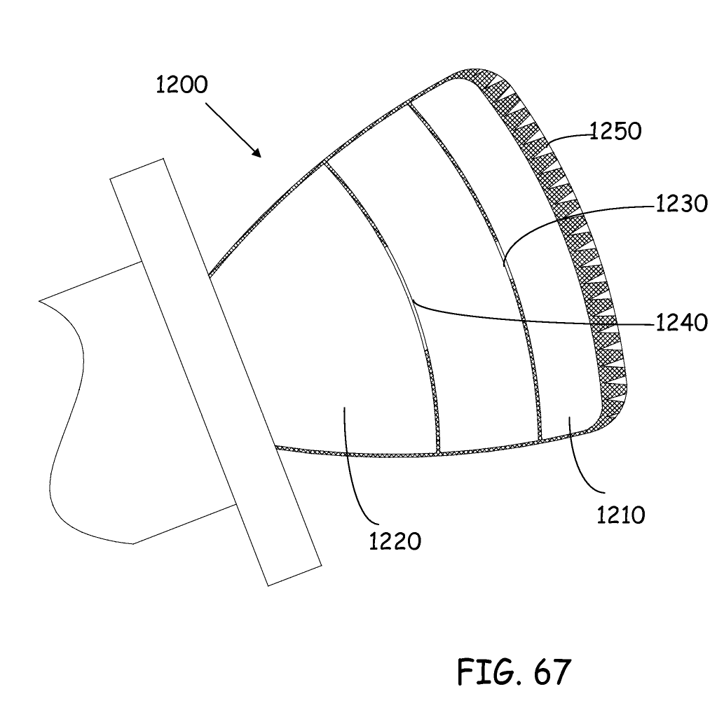

The present invention further comprises a multi-density multi-bagged airbag device 1200 as illustrated in FIGS. 66 and 67. In particular, FIG. 67 depicts a sample embodiment of the disclosure's multi-sectioned airbag consisting of 3 layers. The device, in other embodiments may consist of no less than 2 sections but possibly more than the 3 layers depicted.

In FIG. 67, the outer air sections 1210 closest to the occupant would be the least inflated at the time of impact for lesser air density/softer and higher head impact absorption while the inner sections closest to the steering wheel or dashboard 1220 would be progressively more inflated for higher air density protection to prevent the head impacting the steering wheel or dashboard. In this sample embodiment, the mechanism that controls the amount of progressively less inflation and less density of the outer sections compared to the inner sections would be progressively smaller openings 1230 between the sections of the device closest to the occupant versus progressively larger openings 1240 in the sections closest to the steering wheel or dashboard (or to the back of the front seat, if the device is employed for backseat occupants).

In place of the simple progressively smaller opening sizes from the inner to outer sections of an embodiment of the disclosure (the outer section being the section closest to the occupant and inner section closest to the steering wheel), other embodiments of the disclosure could include as a non-limiting example variable aperture-like settings between each air section that make the outer sections progressively less inflated compared to the inner sections.

As another non-limiting example, this multiple density airbag in other sample embodiments could be additionally constructed with a similar conical shaped hole design 1250 adapted for an inflatable structure as described in embodiments of the disclosure's headrest design with the lower density/larger hole size toward the driver's side of the airbag and the higher density/smaller hole size on embodiments of the disclosure's interior toward the steering wheel or dashboard.

As another non-limiting example, other embodiments could be constructed from small air packets where the lower density of air packets would be located more toward the driver side of the airbag and the higher density of more air packets would be located more toward the steering wheel or dashboard side of the airbag.

Additionally, any section or sections of the device may contain a variation or combination of impact-absorbing features and materials. In the sample embodiment depicted in FIG. 67, just the outer section of an embodiment of the disclosure closest to the occupant contains the conical-shaped impact absorbing design. The material used in such sections could be foam, gel or air, as non-limiting examples.

Although the present invention has been fully described by way of example with reference to the accompanied figures-drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An injury prevention apparatus for a vehicle headrest, comprising shock absorber means, comprising:
a) a pattern of holes that are larger in diameter and/or greater in number in the center of the headrest and/or seatback, and successively smaller in diameter and/or lesser in number as they spread toward the periphery of the headrest and/or seatback; and,
b) each hole in the pattern extending from the front surface to, or near, the back surface of the headrest and/or seatback along a single axis, wherein the front hole is larger in diameter than the back hole thus creating a conical channel.

2. The injury prevention apparatus for a vehicle headrest of claim 1, further comprising a row of holes on the center vertical plane axis and aligned from the front surface to the back surface of the headrest, wherein each hole creates a channel extending from a top surface to a bottom surface of the headrest, to permit the headrest to slightly “flex” around that central vertical plane axis.

3. The injury prevention apparatus for a vehicle headrest of claim 1 further comprising small packets embedded in or around the pattern of holes, wherein the packets comprise impacting absorbing material.

4. The injury prevention apparatus for a vehicle headrest apparatus of claim 1, further comprising a means to connect a vehicle headrest to a vehicle seatback, comprising two shock absorber members wherein each member is positioned with a top end of a shock absorber member attached to a headrest and a bottom end of a shock absorber member attached to a seatback.

5. The injury prevention apparatus for a vehicle headrest of claim 4, wherein said seatback comprises the same shock absorber means as the headrest, comprising:
a) a pattern of holes that are larger in diameter and/or greater in number in the center of the headrest and/or seatback, and successively smaller in diameter and/or lesser in number as they spread toward the periphery of the headrest and/or seatback; and,
b) each hole in the pattern extending from the front surface to, or near, the back surface of the headrest and/or seatback along a single axis, wherein the front hole is larger in diameter than the back hole thus creating a conical channel.

6. The injury prevention apparatus for a vehicle headrest of claim 4, wherein each shock absorber member comprises two “C” shaped members, wherein each member comprises a “C-shaped” bar mounted in the direction of the force of impact to impede backward snapping of the occupant's head, with a top, front end of the “C” bar connecting to a headrest back surface, and a bottom end of the “C” bar extending vertically into a seatback top surface.

7. The injury prevention apparatus for a vehicle headrest of claim 4, wherein each shock absorber member comprises,
a) a piston, cylinder or bar aligned horizontally from a headrest front surface to a headrest back surface;
b) a shock absorber means connected to a front end of the piston, cylinder or bar;
c) two vertical rods aligned from a headrest front surface to a headrest back surface, and extending into a seatback top surface; and,
d) wherein said member resides between a headrest bottom surface and a seatback top surface.

8. The injury prevention apparatus for a vehicle headrest of claim 4, wherein each shock absorber member comprises,
a) a lever comprising an internal and external torus, encasing a shock absorber means;
b) two vertical rods aligned from a headrest front surface to a headrest back surface, and extending into a seatback top surface; and,
c) wherein said member resides between a headrest bottom surface and a seatback top surface.

9. The injury prevention apparatus for a vehicle headrest of claim 4, wherein each shock absorber member comprises,
a) two vertical rods aligned front to back, wherein each rod is connected on the top end to a headrest bottom surface and connected on the bottom end to a lever that is embedded within the seatback top surface;
b) a cylinder connected to the bottom end of the lever, and residing vertically;
c) a shock absorption means connected to the cylinder and compressible upon movement of the lever backward; and
d) wherein the lever, cylinder and spring are configured to allow the headrest to tilt backward upon sufficient impact of an occupant's head against the headrest while impeding the rate of the backward movement.

10. An injury prevention apparatus for a vehicle headrest and/or seatback, comprising a shock absorber means, comprising:
a) a pattern of holes evenly distributed and of uniform diameter on the front surface of the headrest and/or seatback; and,
b) each hole in the pattern extending through a headrest and/or seatback thickness and radiating outward from the center vertical plane axis along a single axis extending to, or near, a back or side surface of a headrest and/or seatback to create a channel,
i) wherein a front hole is larger in diameter than a back hole thus creating a conical channel; or,
ii) wherein the channel is cylindrical and of uniform diameter.

11. The injury prevention apparatus for a vehicle headrest of claim 10, further comprising a row of holes on the center vertical plane axis and aligned from the front surface to the back surface of the headrest, wherein each hole creates a channel extending from a top surface to a bottom surface of the headrest to permit the headrest to slightly “flex” around the central vertical plane axis.

12. The injury prevention apparatus for a vehicle headrest of claim 10, further comprising a means to connect a vehicle headrest to a vehicle seatback, comprising two shock absorber members wherein each member is positioned with a top end of a shock absorber member attached to a headrest and a bottom end of a shock absorber member attached to a seatback.

13. The injury prevention apparatus for a vehicle headrest of claim 12, wherein each shock absorber member comprises two “C” shaped members, wherein each member comprises a “C-shaped” bar mounted in the direction of the force of impact to impede backward snapping of the occupant's head, with a top, front end of the “C” bar connecting to a headrest back surface, and a bottom end of the “C” bar extending vertically into a seatback top surface.

14. The injury prevention apparatus for a vehicle headrest of claim 12, wherein each shock absorber member comprises,
a) a piston, cylinder or bar aligned horizontally from a headrest front surface to a headrest back surface;
b) a shock absorber means connected to a front end of the piston, cylinder or bar;
c) two vertical rods aligned from a headrest front surface to a headrest back surface, and extending into a seatback top surface; and,
d) wherein said member resides between a headrest bottom surface and a seatback top surface.

15. The injury prevention apparatus for a vehicle headrest of claim 12, wherein each shock absorber member comprises,
a) a lever comprising an internal and external torus, encasing a shock absorber means;
b) two vertical rods aligned from a headrest front surface to a headrest back surface, and extending into a seatback top surface; and,
c) wherein said member resides between a headrest bottom surface and a seatback top surface.

16. The injury prevention apparatus for a vehicle headrest of claim 12, wherein each shock absorber member comprises,
a) two vertical rods aligned front to back, wherein each rod is connected on the top end to a headrest bottom surface and connected on the bottom end to a lever that is embedded within the seatback top surface;
b) a cylinder connected to the bottom end of the lever, and residing vertically;
c) a shock absorption means connected to the cylinder and compressible upon movement of the lever backward; and
d) wherein the lever, cylinder and spring are configured to allow the headrest to tilt backward upon sufficient impact of an occupant's head against the headrest while impeding the rate of the backward movement.

17. An injury prevention apparatus for a vehicle headrest, comprising shock absorber means, comprising:
a) two or more layers of shock absorbing material, each layer encasing an adjacent inner layer's sides and back surface, wherein the layers increase in density from a headrest center to a headrest periphery; and,
b) a row of holes on the center vertical plane axis and aligned from the front surface to the back surface of the headrest, wherein each hole creates a channel extending from a top surface to a bottom surface of the headrest to permit the headrest to slightly “flex” around the central vertical plane axis; and,
c) wherein the shock absorbing material may comprise gel, compressed air, foam, or any combination thereof.

18. The injury prevention apparatus for a vehicle headrest of claim 17, further comprising a means to connect a vehicle headrest to a vehicle seatback, comprising two shock absorber members wherein each member is positioned with a top end of a shock absorber member attached to a headrest and a bottom end of a shock absorber member attached to a seatback.

19. The injury prevention apparatus for a vehicle headrest of claim 18, wherein each shock absorber member comprises two “C” shaped members, wherein each member comprises a “C-shaped” bar mounted in the direction of the force of impact to impede backward snapping of the occupant's head, with a top, front end of the “C” bar connecting to a headrest back surface, and a bottom end of the “C” bar extending vertically into a seatback top surface.

20. The injury prevention apparatus for a vehicle headrest of claim 18, wherein each shock absorber member comprises
a) a piston, cylinder or bar aligned horizontally from a headrest front surface to a headrest back surface;
b) a shock absorber means connected to a front end of the piston, cylinder or bar;
c) two vertical rods aligned from a headrest front surface to a headrest back surface, and extending into a seatback top surface; and,
d) wherein said member resides between a headrest bottom surface and a seatback top surface.

21. The injury prevention apparatus for a vehicle headrest of claim 18, wherein each shock absorber member comprises
a) a lever comprising an internal and external torus, encasing a shock absorber means;
b) two vertical rods aligned from a headrest front surface to a headrest back surface, and extending into a seatback top surface; and,
c) wherein said member resides between a headrest bottom surface and a seatback top surface.

22. The injury prevention apparatus for a vehicle headrest of claim 18, wherein each shock absorber member comprises
a) two vertical rods aligned front to back, wherein each rod is connected on the top end to a headrest bottom surface and connected on the bottom end to a lever that is embedded within the seatback top surface;
b) a cylinder connected to the bottom end of the lever, and residing vertically;
c) a shock absorption means connected to the cylinder and compressible upon movement of the lever backward; and
d) wherein the lever, cylinder and spring are configured to allow the headrest to tilt backward upon sufficient impact of an occupant's head against the headrest while impeding the rate of the backward movement.
